(19) United States
(12) Patent Application Publication
(10) Pub. No.: US 2026/0341053 A1
(43) Pub. Date: Oct. 29, 2026

(54) Identification of Immature Cell Types Utilizing Imaging

(71) Applicant: Beckman Coulter, Inc., Brea, CA (US)

(72) Inventors: Jiuliu LU, Miami, FL (US); Carol QUON, Genoa, NV (US); Bart WANDERS, Trabuco Canyon, FL (US); Bian QIAN, Fort Lauderdale, FL (US); Marco ZULETA, Lynwood, CA (US); Gabriel SANTOS, Miami, FL (US)

(21) Appl. No.: 19/101,569

(22) PCT Filed: Aug. 4, 2023
(86) PCT No.: PCT/US2023/029498

§ 371 Date: Feb. 5, 2025

Related U.S. Application Data
(60) Provisional application No. 63/395,434, filed on Aug. 5, 2022.

(51) Int. Cl. G06V 20/69; G01N 1/30; G01N 15/01; G01N 15/14; G01N 15/1433; G06T 7/00; G06V 10/82

(52) U.S. Cl. CPC G06V 20/698; G01N 1/30; G01N 15/1433; G01N 15/147; G06T 7/0012; G06V 10/82; G01N 2015/014; G01N 2015/1486; G06T 2207/20084; G06T 2207/30024; G06T 2207/30242

(57) ABSTRACT

Maturity of a cell may be detected using a computer-implemented image analysis method which comprises capturing an image of a stained blood cell with a camera and then determining maturity for the stained blood cell. This determination may include classifying the stained blood cell before generating the stained blood cell's maturity. Corresponding systems may also be implemented, and approaches used for determining maturity of a cell may be used for detecting other characteristics, such as infection by malaria or other parasite.

### BACKGROUND

Blood cell analysis is one of the most commonly performed medical tests for providing an overview of a patient's health status. A blood sample can be drawn from a patient's body and stored in a test tube containing an anticoagulant to prevent clotting. This blood sample may contain a variety of particles whose identification may be clinically useful. For example, young platelets which contain increased levels of mRNA and rRNA compared to mature cells (referred to as reticulated platelets or immature platelets) normally constitute 4.5% or less of total platelets in a sample. However, increased proportions of immature platelets can be an indication of thrombopoiesis, and may be an early indicator of marrow recovery in patients who have undergone chemotherapy and stem cell transplantation. As another example, as red blood cells develop, they pass through an intermediate stage called a reticulocyte. These reticulocytes can be classified as immature reticulocytes and mature reticulocytes, and the ratio of immature reticulocytes to total reticulocytes (referred to as the immature reticulocyte fraction, or IRF) has been found to have clinical utility, such as described in Mitrani. et. al., The Immature Reticulocyte Fraction As an Aid in the Diagnosis and Prognosis of Parvovirus B19 Infection in Sickle Cell Disease, Blood (2018) 132 (Supplement 1); 3678.

Identification of particles such as platelets and reticulocytes can be difficult due to the relatively small size of the particles. Quantifying between mature vs immature states of cells can be even more challenging due to factors such as the size of the cells and the relatively minute differences related to particular particle types (e.g., immature platelet vs mature platelet, or immature reticulocyte vs mature reticulocyte). Such identification can be difficult in many sample analysis systems, including in an image-based system. Accordingly, there is a need for technology which can identify particles such as immature platelets and reticulocytes based on data gathered by image-based sample processing systems.

### SUMMARY

Described herein are devices, systems and methods for identifying objects such as immature reticulocytes and platelets in data captured by image-based sample processing systems.

An illustrative implementation of such technology relates to a computer-implemented image analysis method for detecting maturity of a blood cell. As described herein, such an image analysis method may include capturing an image of a stained blood cell with a camera, classifying the stained blood cell, and determining a maturity of the stained blood cell after the stained blood cell is classified.

A first aspect of the present invention relates to a computer-implemented image analysis method for detecting maturity of a blood cell, comprising: capturing an image of a stained blood cell with a camera; classifying the stained blood cell, e.g. by using the image of the stained blood cell; and determining a maturity of the stained blood cell after the stained blood cell is classified, e.g. by using the classification of the stained blood cell.

In particular, according to the present invention, classifying the stained blood cell comprises determining a blood cell type of the stained blood cell. For example, the blood cell type of the stained blood cell may be one of at least White blood Cell (WBC), Platelet and Reticulocyte. Alternatively or additionally, according to the present invention, classifying the stained blood cell comprises selecting a blood cell type of the stained blood cell from a blood cell type set, wherein the blood cell type set comprises at least WBC, Platelet and Reticulocyte.

Exemplarily, the determination of the maturity of the stained blood cell is based on the blood cell type of the stained blood cell.

The method according to the first aspect of the present invention may further comprise determining, based on the blood cell type of the stained blood cell, whether the stained blood cell is a blood cell of interest. In this case, determining the maturity of the stained blood cell is carried out if the stained blood cell is a blood cell of interest. If the stained blood cell is not a blood cell of interest, the method may comprise discarding and/or removing the image of the stained blood cell. For example, the stained blood cell is a blood cell of interest if its blood cell type is Platelet or Reticulocyte. In particular, the stained blood cell is not a blood cell of interest if its blood cell type is neither Platelet nor Reticulocyte, e.g. if its blood cell type is WBC.

Exemplarily, the method according to the first aspect of the present invention further comprises: treating a blood sample with a lysing, staining, or staining and lysing agent; and flowing the blood sample through a flowcell and past the camera; and capturing the image of the stained blood cell with the camera is performed while the blood sample is flowing through the flowcell and past the camera. In particular, in this example, the stained blood cell is contained in the blood sample.

In some examples, classifying the stained blood cell comprises classifying the stained blood cell as at least one of a reticulocyte or a platelet.

The method according to the first aspect of the present invention further comprises determining at least one of an immature reticulocyte fraction and an immature platelet fraction for the blood sample.

In particular, determining the at least one of an immature reticulocyte fraction and an immature platelet fraction for the blood sample may be carried out by using the image of the stained blood cell and a plurality of images, each image of the plurality of images depicting a respective stained blood cell of the blood sample. For instance, determining the at least one of an immature reticulocyte fraction and an immature platelet fraction for the blood sample may comprise, for each image of the plurality of images, classifying the respective stained blood cell depicted in said each image and determining a maturity of said respective stained blood cell after said respective stained blood cell is classified, e.g. by using the classification of said respective stained blood cell.

For example, determining the immature reticulocyte fraction may comprise determining a number of images of the plurality of images that depict an immature reticulocyte cell.

Alternatively or additionally, determining the immature reticulocyte fraction may comprise determining a number of images of the plurality of images that depict an immature platelet cell.

For instance, classifying the stained blood cell may comprise utilizing an artificial intelligence or machine learning model. In particular, classifying the stained blood cell may comprise determining the blood cell type of the stained blood cell by using a convolutional neural network and at least a portion of the image of the stained blood cell. For example, the convolutional neural network is configured, e.g. trained, to process at least a portion of the image of the stained blood cell and thereby determine the blood cell type. In particular, the convolutional neural network is a classifier configured, e.g. trained, to assign, by using at least a portion of the image of the stained blood cell as input, a blood cell type of a set of blood cell types to the stained blood cell. In particular, a portion of the image comprises a set of pixels of the image. The set of pixels may be a proper subset of the pixels of the image or may comprise all the pixels of the image.

Additionally or alternatively, classifying the stained blood cell comprises pixel analysis involving, for instance, an HSV space. In particular, according to the present invention, the foreground of the image is a set of pixels of the image, in particular the portion of the image described above. In some examples, classifying the stained blood cell comprises determining a set of image intensities and identifying a foreground in the image based on said set of image intensities.

Exemplarily, the method according to the first aspect of the present invention further comprises: calculating an average red intensity of pixels in the foreground of the image and an average blue intensity of pixels in the foreground of the image; and classifying the stained blood cell based on the average red intensity and the average blue intensity. In particular, the average blue intensity and the average red intensity are comprised in the aforementioned set of image intensities.

Exemplarily, determining the maturity of the stained blood cell comprises utilizing a pixel foreground analysis. In particular, according to the present invention, the foreground count is the number of pixels of the image of the stained blood cell that are comprised in the foreground.

For instance, determining the maturity of the stained blood cell comprises determining whether the foreground count fulfils certain conditions of a set of maturity conditions (e.g., each condition of a set of maturity conditions, or a majority of conditions in a set of maturity conditions). If the foreground count fulfils the certain conditions of a set of maturity conditions, the stained blood cell is considered mature. If, instead, the foreground count does not fulfill of the maturity conditions (e.g., fails to fulfill each condition, or fails to fulfill a majority of conditions), the stained blood cell is considered immature.

Alternatively, determining the maturity of the stained blood cell comprises determining whether the foreground count fulfils each condition of a set of immaturity conditions. If the foreground count fulfils all the conditions of a set of immaturity conditions, the stained blood cell is considered immature. If, instead, the foreground count does not fulfill at least one condition of the set of immaturity conditions, the stained blood cell is considered mature.

For instance, determining the maturity of the stained blood cell comprises determining whether the pixel foreground count exceeds a threshold amount. In this case, in particular, the set of immaturity conditions comprises the condition that the pixel foreground count exceeds the threshold amount.

Exemplarily, the method comprises determining that the stained blood cell is immature based on determining the pixel foreground count exceeds a threshold amount.

A second aspect of the present invention refers to an image analysis system for detecting maturity of a blood cell, comprising: a camera configured to capture an image of a stained blood cell; a processor configured to classify the stained blood cell, (e.g., by using the image of the stained blood cell); and determining a maturity of the stained blood cell after the stained blood cell is classified, e.g. by using the classification of the stained blood cell. Alternatively, the maturity determination step can be part of the classification step (e.g., where an immature cell type is part of the initial classification step—for instance, a primary classifier trained to make an immature cell type distinction).

The image analysis system may further comprise a flowcell and the camera may be configured to capture the image of the stained blood cell when a blood sample is flowing through the flowcell and past the camera. In particular, the flowcell and the camera are arranged with respect to one another so that the flowcell is configured to convey at least a portion of the sample fluid through a viewing zone of the camera.

Exemplarily, the processor is configured to classify the stained blood cell as at least one of a reticulocyte or a platelet. Alternatively or additionally, the processor is further configured to determine at least one of an immature reticulocyte fraction and an immature platelet fraction for the blood sample.

Additionally or alternatively, the processor may be configured to classify the stained blood cell utilizing a convolutional neural network.

Additionally or alternatively, the processor may be configured to classify the stained blood cell based on identifying a foreground in the image based an intensity of each pixel in the image.

For instance, the processor is further configured to calculate an average red intensity of pixels in the foreground of the image and an average blue intensity of pixels in the foreground of the image. Moreover, the processor may be configured to classify the stained blood cell based on the average red intensity and the average blue intensity.

Exemplarily, the processor is configured to determine the maturity of the stained blood cell based on a pixel foreground count.

In particular, the processor is configured to determine that the stained blood cell is immature based on the pixel foreground count exceeding a threshold amount.

For instance, the image analysis system according to the first aspect of the present invention is configured to carry out the methods according to the second aspect of the present invention.

A third aspect of the present invention refers to a machine comprising a camera and means for classifying and determining maturity of cells in images captured by the camera.

A fourth aspect of the present invention refers to a computer program product. The computer program product comprises instructions which, when the program is executed by a computer, cause the computer to carry out the method according to the first aspect of the present invention.

A fifth aspect of the present invention refers to a computer-readable medium, e.g. a transitory computer readable medium comprising instructions which, when executed by a computer, cause the computer to carry out the method according to first aspect of the present invention.

Additional aspects of the invention include the modules used to aid in imaging of a biological sample. A lighting module is used to illuminate a sample to provide favorable lighting conditions for an image capture device (e.g., camera) to take images of cells of the sample. A staining module used to stain biological cells (e.g., an interior or nuclear region of blood cells) in order to visualize an interior region of the cells to aid in classification and/or maturity determination of the cells.

It should be noted that any of the various features of the aspects disclosed herein can be included or combined in each of those aspects.

While multiple examples are described herein, still other examples of the described subject matter will become apparent to those skilled in the art from the following detailed description and drawings, which show and describe illustrative examples of disclosed subject matter. As will be realized, the disclosed subject matter is capable of modifications in various aspects, all without departing from the spirit and scope of the described subject matter. Accordingly, the drawings and detailed description are to be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is a schematic illustration, partly in section and not to scale, showing operational aspects of an exemplary flow cell and high optical resolution imaging device for sample image analysis using digital image processing.

FIG. 2 illustrates a slide-based vision inspection system in which aspects of the disclosed technology may be used.

FIG. 3 illustrates a perspective view of an exemplary lighting module in conjunction with another exemplary flow cell and high optical resolution imaging device for sample image analysis using digital image processing.

FIG. 4 illustrates a perspective view of the lighting module of FIG. 3, with a portion of the housing omitted to show light emitters, focusing lenses, dichroic elements, and a collimating lens of the lighting module.

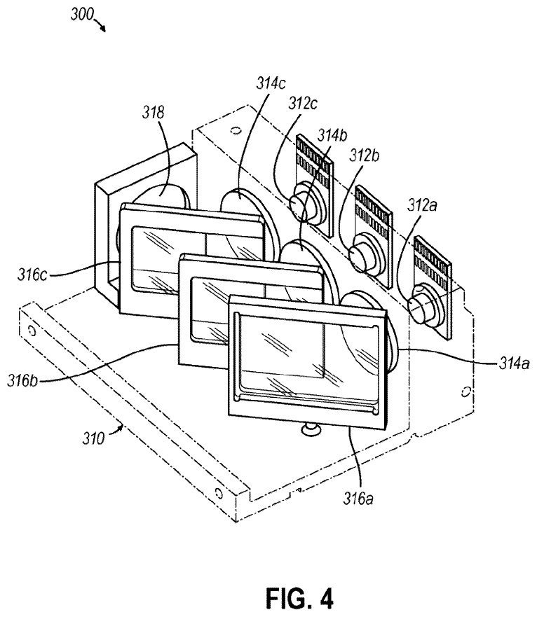

FIG. 5 illustrates a top plan view of the lighting module of FIG. 3, showing light traveling from each of the light emitters to the collimating lens.

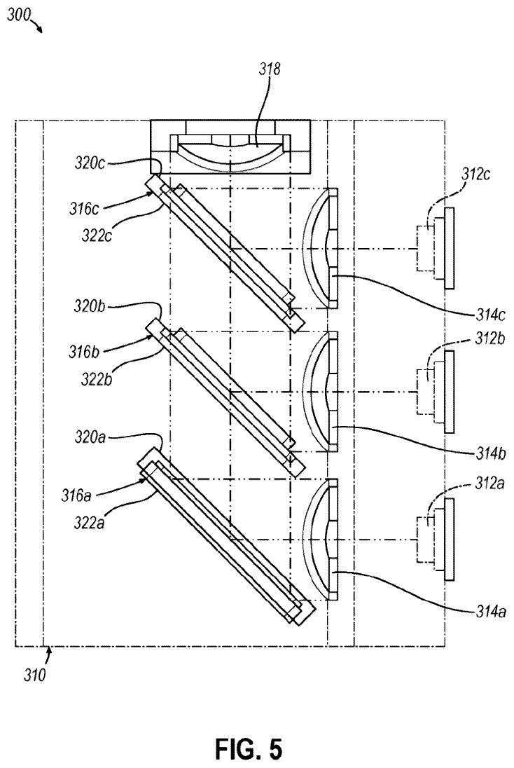

FIG. 6A illustrates a perspective view of an exemplary staining module for mixing a staining agent with a sample to form a sample mixture, and for incubating the sample mixture, showing the lamination of ferromagnetic sheets to a housing of the staining module.

FIG. 6B illustrates a perspective view of the staining module of FIG. 6A, showing the wrapping of the ferromagnetic sheets to the housing with adhesive tape.

FIG. 6C illustrates a perspective view of the staining module of FIG. 6A, showing the winding of a heating coil of the staining module about the housing.

FIG. 7A illustrates a side elevation view of an exemplary multi-chamber staining module for mixing a staining agent with a sample to form a sample mixture, and for incubating the sample mixture.

FIG. 7B illustrates a top plan view of the multi-chamber staining module of FIG. 7A.

FIG. 8 illustrates a process which may be used to stain a sample.

FIG. 9 illustrates a process which may be used to determine blood cell maturity, and determine the maturity of particles in a sample.

FIG. 10 illustrates a process which may be used to classify particles based on morphological features of an imaged cell.

FIG. 11 illustrates an example machine learning model.

FIG. 12 illustrates an example of a layer such as may be included in a machine learning model as shown in FIG. 11.

FIG. 13 illustrates a method which may be used to generate a maturity for an imaged cell.

FIG. 14 illustrates a method in which maturity information is used to generate overall information for a biological sample.

FIG. 15 depicts a method in which a maturity for a cell is created as part of classifying the cell.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to, among other things, apparatus, systems, compositions, and methods for analyzing a sample containing particles. In one embodiment, the invention relates to an automated particle imaging system which comprises an analyzer which may be, for example, a visual analyzer. In some embodiments, the visual analyzer may further comprise a processor to facilitate automated analysis of the images.

According to some aspects of this disclosure, a system comprising a visual analyzer may be provided for obtaining images of a sample comprising particles suspended in a liquid. Such a system may be useful, for example, in characterizing particles in biological fluids, such as detecting and quantifying erythrocytes, immature reticulocytes, mature reticulocytes, nucleated red blood cells, immature platelets, and/or white blood cells, including white blood cell differential counting, categorization and subcategorization and analysis. Other similar uses such as characterizing blood cells from other fluids and/or identifying parasites such as malaria are also contemplated.

The identification of various types of particles in a blood sample is an exemplary application for which the subject matter is particularly well suited, though other types of body fluid samples may be used. For example, aspects of the disclosed technology may be used in analysis of a non-blood body fluid sample comprising blood cells (e.g., white blood cells and/or red blood cells), such as serum, bone marrow, lavage fluid, effusions, exudates, cerebrospinal fluid, pleural fluid, peritoneal fluid, and amniotic fluid. It is also possible that the sample can be a solid tissue sample, e.g., a biopsy sample that has been treated to produce a cell suspension. The sample may also be a suspension obtained from treating a fecal sample. A sample may also be a laboratory or production line sample comprising particles, such as a cell culture sample. The term sample may be used to refer to a sample obtained from a patient or laboratory or any fraction, portion or aliquot thereof. The sample can be diluted, divided into portions, or stained in some processes.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes permeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.

### I. System Overview

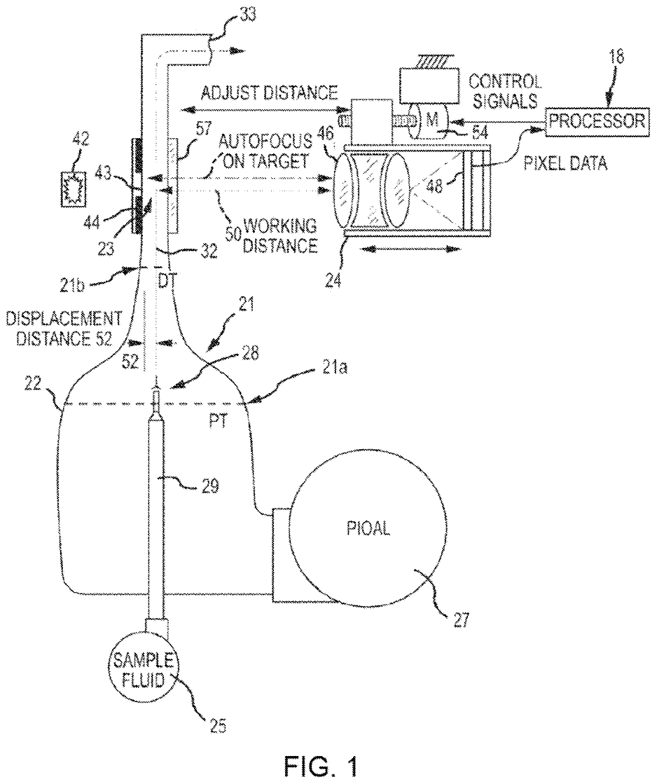

Turning now to the drawings, FIG. 1 schematically shows an exemplary flow cell 22 for conveying a sample fluid through a viewing zone 23 of a high optical resolution imaging device 24 in a configuration for imaging microscopic particles in a sample flow stream 32 using digital image processing. Flow cell 22 is coupled to a source 25 of sample fluid which may have been subjected to processing, such as contact with a particle contrast agent composition and heating. Flow cell 22 is also coupled to one or more sources 27 of a particle and/or intracellular organelle alignment liquid (PIOAL), such as a clear glycerol solution having a viscosity that is greater than the viscosity of the sample fluid.

The sample fluid is injected through a flattened opening at a distal end 28 of a sample feed tube 29, and into the interior of the flow cell 22 at a point where the PIOAL flow has been substantially established resulting in a stable and symmetric laminar flow of the PIOAL above and below (or on opposing sides of) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone 21 where the flowpath narrows. Hence, the decrease in flowpath thickness at zone 21 can contribute to a geometric focusing of the sample stream 32. The sample fluid ribbon 32 is enveloped and carried along with the PIOAL downstream of the narrowing zone 21, passing in front of, or otherwise through the viewing zone 23 of, the high optical resolution imaging device 24 where images are collected, for example, using a Charge-Coupled Device (CCD) 48. In this way, flow imaging is performed where images from the flowing sample stream and the cellular material contained therein are collected. Processor 18 can receive, as input, pixel data from CCD 48. The sample fluid ribbon flows together with the PIOAL to a discharge 33.

As shown here, the narrowing zone 21 can have a proximal flowpath portion 21a having a proximal thickness PT and a distal flowpath portion 21b having a distal thickness DT, such that distal thickness DT is less than proximal thickness PT. The sample fluid can therefore be injected through the distal end 28 of sample tube 29 at a location that is distal to the proximal portion 21a and proximal to the distal portion 21b. Hence, the sample fluid can enter the PIOAL envelope as the PIOAL stream is compressed by the zone 21, wherein the sample fluid injection tube has a distal exit port through which sample fluid is injected into flowing sheath fluid, the distal exit port bounded by the decrease in flowpath size of the flow cell.

The digital high optical resolution imaging device 24 with objective lens 46 is directed along an optical axis that intersects the ribbon-shaped sample stream 32. The relative distance between the objective 46 and the flow cell 33 is variable by operation of a motor drive 54, for resolving and collecting a focused digitized image on a photosensor array. Additional information regarding the construction and operation of an exemplary flow cell such as shown in FIG. 1 is provided in U.S. Pat. No. 9,322,752, entitled “Flow cell Systems and Methods for Particle Analysis in Blood Samples,” filed on Mar. 17, 2014, the disclosure of which is hereby incorporated by reference in its entirety.

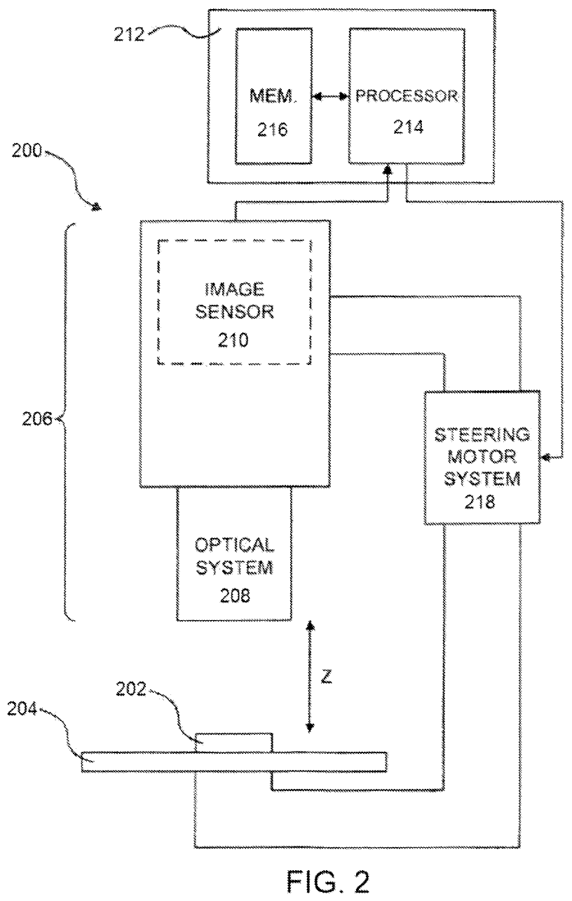

Aspects of the disclosed technology may also be applied in contexts other than flow cell systems such as shown in FIG. 1. For example, FIG. 2 illustrates a slide-based vision inspection system 200 in which aspects of the disclosed technology may be used. In the system shown in FIG. 2, a slide 202 comprising a sample, such as a blood sample, is placed in a slide holder 204. The slide holder 204 may be adapted to hold a number of slides or only one, as illustrated in FIG. 2. An image capturing device 206, comprising an optical system 208 and an image sensor 210, is adapted to capture image data depicting the sample in the slide 202.

The image data captured by the image capturing device 206 can be transferred to an image processing device 212. The image processing device 112 may be an external apparatus, such as a personal computer, connected to the image capturing device 206. Alternatively, the image processing device 212 may be incorporated in the image capturing device 206. The image processing device 212 can comprise a processor 214, associated with a memory 216, configured to determine changes needed to determine differences between the actual focus and a correct focus for the image capturing device 206. When the difference is determined an instruction can be transferred to a steering motor system 218. The steering motor system 218 can, based upon the instruction from the image processing device 212, alter the distance z between the slide 202 and the optical system 208. Descriptions of approaches which may be used for focusing using this type of setup are provided in U.S. Pat. No. 9,857,361, entitled “Flowcell, sheath fluid, and autofocus systems and methods for particle analysis in urine samples,” issued on Jan. 2, 2018, and U.S. Pat. No. 10,705,008, entitled “Autofocus systems and methods for particle analysis in blood samples,” issued on Jul. 7, 2020 the disclosures of which are hereby incorporated by reference in their entirety, the disclosures of which is hereby incorporated by reference in their entirety.

### II. Example of Lighting Module

In the context of imaging, including the flow imaging concepts discussed for biological imaging, proper illumination is important in order to enable proper visualization of the biological material (e.g., blood cells). The illumination is an important criterion of an image capture device (e.g., camera) capturing clear and well-lit sample images—for instance, in order for an algorithm to properly identify a cell type.

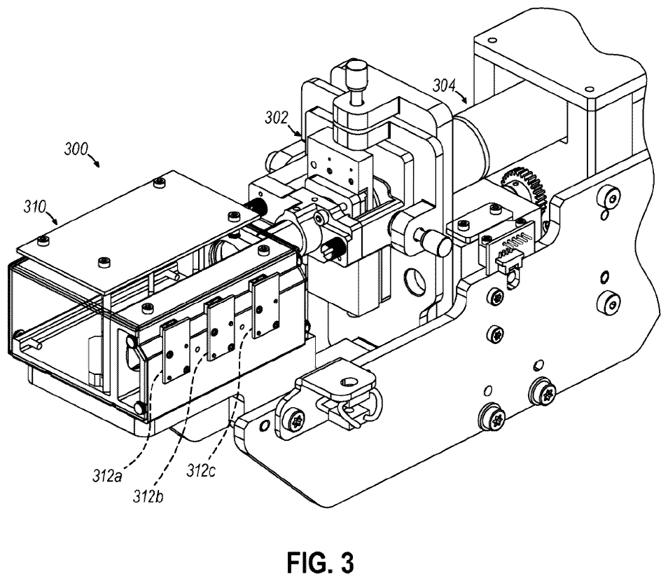

In a system such as shown in FIG. 1 or FIG. 2, a lighting module (also referred to as an illumination system or a lighting device) 300 such as shown in FIG. 3 may be used to illuminate cells imaged by a camera such as the high optical resolution imaging device 24 of FIG. 1, or the image sensor 210 of FIG. 2. For example, the lighting module 300 may be incorporated in place of the light source 42 shown in FIG. 1. FIG. 3 shows the lighting module 300 in conjunction with an exemplary flowcell 302, which may be configured and operable like the flow cell 22 shown in FIG. 1, as well as a high optical resolution imaging device 304, which may be configured and operable like the high optical resolution imaging device 24 shown in FIG. 1. As shown, the lighting module 300 is positioned on a side of the flowcell 302 opposite the high optical resolution imaging device 304 for illuminating an analysis region such as a viewing zone (also referred to as image capture region or an imaging region) of the flowcell 302 as a sample moves through the analysis region to facilitate the capturing of images of the sample by the high optical resolution imaging device 304. The cells of the sample may be stained prior to moving through the flowcell 302 via a staining module, for example, such as either staining module 400, 500 described below.

In the example shown, the lighting module 300 includes a housing 310, a plurality of light emitters 312a, 312b, 312c, a plurality of focusing lenses 314a, 314b, 314c, a plurality of dichroic elements 316a, 316b, 316c, and a collimating lens 318. The light emitters 312a, 312b, 312c may each be any suitable light source including, for example, an arc lamp, a light emitting diode (LED), or any other suitable light emitter for providing either pulsed or continuous illumination. In some embodiments, the light emitters 312a, 312b, 312c may each be configured to emit a light of a different color than the other light emitters 312a, 312b, 312c. For example, the first light emitter 312a may include a red LED configured to emit red light having a wavelength of between about 600 nanometers and about 650 nanometers, such as about 620 nanometers; the second light emitter 312b may include a green LED configured to emit green light having a wavelength of between about 470 nanometers and about 600 nanometers, such as about 525 nanometers; and/or the third light emitter 312c may include a blue LED configured to emit blue light having a wavelength of between about 400 nanometers and about 470 nanometers, such as about 450 nanometers.

The light emitters 312a, 312b, 312c are each mounted to a side of the housing 310 in a row that extends generally parallel to an optical axis of the high optical resolution imaging device 304, such that the light emitted by each light emitter 312a, 312b, 312c may be initially projected into an interior of the housing 310 in a direction generally perpendicular to the optical axis of the high optical resolution imaging device 304. As shown, each focusing lens 314a, 314b, 314c is mounted within the housing 310 and is axially aligned with a corresponding one of the light emitters 312a, 312b, 312c for focusing the light emitted by the corresponding light emitter 312a, 312b, 312c.

Each dichroic element 316a, 316b, 316c is mounted within the housing 310 in-line with a corresponding one of the light emitters 312a, 312b, 312c for reflecting and/or filtering the light emitted from one or more of the light emitters 312a, 312b, 312c (and focused by the corresponding focusing lens(es) 314a, 314b, 314c). In this regard, each dichroic element 316a, 316b, 316c of the present example includes a corresponding reflective side 320a, 320b, 320c and a corresponding filtering side 322a, 322b, 322c. Each dichroic element 316a, 316b, 316c is oriented obliquely relative to the optical axis of the high optical resolution imaging device 304 and relative to the light received from the corresponding focusing lens 314a, 314b, 314c. For example, each dichroic element 316a, 316b, 316c may be oriented at an angle of about 45 degrees relative to the optical axis of the high optical resolution imaging device 304. More particularly, each dichroic element 316a, 316b, 316c is oriented such that the corresponding reflective side 320a, 320b, 320c faces generally toward both the corresponding focusing lens 314a, 314b, 314c and the high optical resolution imaging device 304 while the corresponding filtering side 322a, 322b, 322c faces generally away from both the corresponding focusing lens 314a, 314b, 314c and the high optical resolution imaging device 304.

In this manner, the reflective side 320a, 320b, 320c of each dichroic element 316a, 316b, 316c may be configured to reflect the light emitted from the corresponding light emitter 312a, 312b, 312c (and focused by the corresponding focusing lens 314a, 314b, 314c) and traveling generally perpendicular to the optical axis of the high optical resolution imaging device 304 such that the reflected light travels generally parallel to the optical axis of the high optical resolution imaging device 304. For example, the reflective side 320a of the first dichroic element 316a may be configured to reflect the light emitted from the first light emitter 312a (and focused by the first focusing lens 314a) such that the reflected light travels generally parallel to the optical axis of the high optical resolution imaging device 304; the reflective side 320b of the second dichroic element 316b may be configured to reflect the light emitted from the second light emitter 312b (and focused by the second focusing lens 314b) such that the reflected light travels generally parallel to the optical axis of the high optical resolution imaging device 304; and/or the reflective side 320c of the third dichroic element 316c may be configured to reflect the light emitted from the third light emitter 312c (and focused by the third focusing lens 314c) such that the reflected light travels generally parallel to the optical axis of the high optical resolution imaging device 304.

In addition, the filtering side 322a, 322b, 322c of at least some dichroic elements 316a, 316b, 316c may be configured to filter the light received from one or more of the other dichroic elements 316a, 316b, 316c. For example, the filtering side 322b of the second dichroic element 316b may be configured to filter the light reflected from the first dichroic element 316a; and/or the filtering side 322c of the third dichroic element 316c may be configured to filter the light reflected from the second dichroic element 316b, and/or to filter the light reflected from the first dichroic element 316a (and filtered by the second dichroic element 316b). In this regard, the filtering side 322a, 322b, 322c of each dichroic element 316a, 316b, 316c may be configured to inhibit the passage of light therethrough that has a wavelength below a corresponding predetermined threshold. For example, the filtering side 322b of the second dichroic element 316b may be configured to inhibit the passage of light therethrough that has a wavelength below a predetermined threshold of about 596 nanometers; and/or the filtering side 322c of the third dichroic element 316c may be configured to inhibit the passage of light therethrough that has a wavelength below a predetermined threshold of about 484 nanometers. In some cases, the filtering sides 322b, 322c of the second and third dichroic elements 316b, 316c may be configured to allow the passage of about 95% of light therethrough that has a wavelength above the corresponding predetermined threshold and/or to inhibit the passage of about 99% of light therethrough that has a wavelength below the corresponding predetermined threshold.

Thus, the light emitted by the first light emitter 312a may be focused by the first focusing lens 314a, reflected by the reflective side 320a of the first dichroic element 316a, filtered by the filtering side 322b of the second dichroic element 316b, and filtered by the filtering side 322c of the third dichroic element 316c; the light emitted by the second light emitter 312b may be focused by the second focusing lens 314b, reflected by the reflective side 320b of the second dichroic element 316b, and filtered by the filtering side 322c of the third dichroic element 316c; and/or the light emitted by the third light emitter 312c may be focused by the third focusing lens 314c, and reflected by the reflective side 320c of the third dichroic element 316c. In this manner, the light emitted by the light emitters 312a, 312b, 312c may be tuned via dichroic elements 316a, 316b, 316c to improve the whiteness of the light prior to being converged together by the collimating lens 318 into a single collimated beam of white light, which may then be transmitted out of the housing 310 toward the flowcell 302.

It will be appreciated that in cases where the first light emitter 312a includes a red LED, the red light emitted by the first light emitter 312a may be substantially unaffected by the filtering sides 322b, 322c of the second and third dichroic elements 316b, 316c due to the relatively high wavelength of the red light, which may be greater than the threshold of either filtering side 322b, 322c.

The collimated beam of white light formed by the collimating lens 318 may be transmitted toward the flowcell 302 via a lightpipe (also referred to as a lighting column or a lightguide), such as a hexagonal lightpipe. The lightpipe may be configured to collect the collimated beam of white light, randomize the collimated beam of white light, and/or converge the collimated beam of white light onto the flowcell 302 (e.g., at a viewing zone of the flowcell 302). The lightpipe may be positioned relative to the collimating lens 318 such that the collimated beam converges to a point (e.g., phases) at the entry of the lightpipe. The lightpipe may be mounted to a flowcell holder (not shown) that holds the flowcell 302 in order to fixedly secure the exit of the lightpipe relative to the flowcell 302, such as flowcell holder 700 described below. In this way, the distance between the lightpipe and the flowcell 302 is fixed since the lightpipe and flowcell 302 are operatively connected through the flowcell holder 700.

In some embodiments, the light emitters 312a, 312b, 312c may be configured to provide pulsed illumination in a synchronized manner (e.g., simultaneously) with each other in a profile so as to capture a still image of the sample cells moving through the flowcell 302. For example, an objective lens of the high optical resolution imaging device 304 may open; then the light emitters 312a, 312b, 312c may emit pulses of light simultaneously; then an image of the sample cells may be captured by the high optical resolution imaging device 304; then the objective lens of the high optical resolution imaging device 304 may close. This process may be repeated any suitable number of iterations. In some cases, the duration of each pulse may be between about 1 microsecond and about 3 microseconds, such as about 2 microseconds. The pulse frequency may depend on the camera frame acquisition frequency, which may be between about 220 frames per second and about 300 frames per second. For example, 220 frames per second may correspond to one picture about every 4.5 milliseconds. The objective lens may be open for about 100 microseconds, which may be sufficient to capture one image. In some embodiments a higher frame rate may be used, such as with a reduced field of view. Increased speeds may be used depending on the particular application, type of camera used, etc. It will be appreciated that an increase in speed may provide more data (e.g., more images of more sample cells) in less time, while a smaller field of view may remove visual landmarks (e.g., “black bars”) that could be used for focusing. It will also be appreciated that the pixel rate may contribute to the amount of data provided. For example, increasing the pixel rate may compensate for decreasing the framerate to provide the same amount of data.

In some embodiments, the light emitters 312a, 312b, 312c may be configured to emit pulses of light sequentially to operate in a diagnostic mode. For example, a time delay may be provided between each flash to capture three separate images of a particular sample cell at three distinct moments along the path of the sample cell. The pixel representation of distance may then be used to calculate the velocity of the sample cell, to determine whether the sample cells are accelerating or decelerating, and/or to determine if the flow is too fast to obtain reliable data. This diagnostic mode may be selectively entered into and exited out of. For example, after operating in the diagnostic mode, the light emitters 312a, 312b, 312c may be configured to emit pulses of light simultaneously as described above in the primary operating mode.

### III. Examples of Staining Module

In some embodiments, the flow imaging systems incorporate stain and an associated staining module in order to augment visualization of the biological material (e.g., blood cells). The staining can be useful, for instance, to staining an interior cellular region of a white blood cell to visualize an interior nuclear structure to help identify a cell type (e.g., subset of white blood cell types—e.g., identification as a neutrophil, lymphocytes, monocytes, eosinophils, or basophils), In some examples, the stain is applied to an exterior surface of a cell to augment visualization of the cell (e.g., an exterior stain for red blood cells or platelets).

### A. Example of Single-Chamber Staining Module

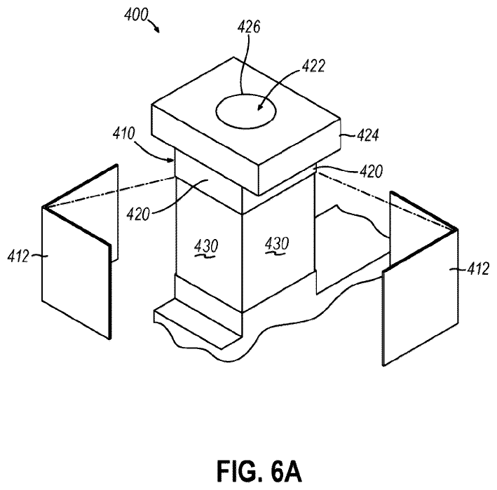

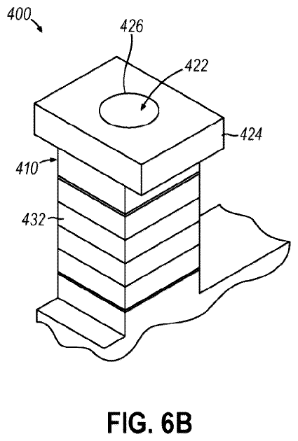

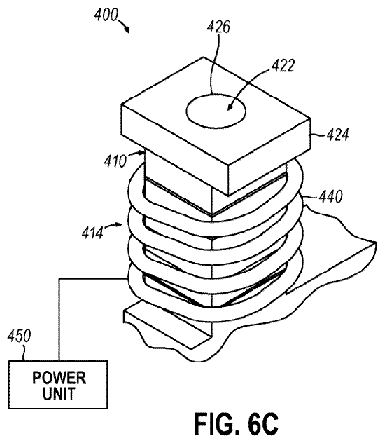

In a system such as shown in FIG. 1 or FIG. 2, a staining module (also referred to as a staining device) 400 such as shown in FIGS. 6A-6C may be used to both mix a sample with a staining agent and incubate the sample mixture via heating prior to the cells within the sample mixture being imaged by a camera such as the high optical resolution imaging device 24 of FIG. 1, or the image sensor 210 of FIG. 2. For example, the staining module 400 may be incorporated in place of the source 25 shown in FIG. 1 or between the source 25 and the sample feed tube 29 shown in FIG. 1, to facilitate mixing of the sample with the staining agent and incubation of the sample mixture prior to capturing of images of the sample by the high optical resolution imaging device 24. The staining agent may include any suitable composition. For example, the staining agent may be composed in accordance with any one or more teachings of U.S. Pat. No. 9,279,750, entitled “Method and Composition for Staining and Sample Processing,” issued on Mar. 8, 2016, the disclosure of which is hereby incorporated by reference in its entirety; and/or U.S. Pat. No. 9,322,753, entitled “Method and Composition for Staining and Processing a Urine Sample,” issued on Apr. 26, 2016, the disclosure of which is hereby incorporated by reference in its entirety; and/or US Pub. No. 2021/0108994, entitled “Method and Composition for Staining and Sample Processing,” published on Apr. 15, 2021, the disclosure of which is hereby incorporated by reference in its entirety.

In the embodiment shown, the staining module 400 includes a housing 410, a pair of ferromagnetic sheets 412, and a heater in the form of a heating coil 414 (FIG. 6C). In various embodiments, heating coil 414 can comprise a resistive coil, or alternatively an inductive coil. As best shown in FIG. 6A, the housing 410 includes a plurality of (e.g., four) sidewalls 420 which collectively define an interior chamber 422 (also referred to as a sample reservoir) for receiving the staining agent and the sample, mixing the staining agent and the sample to form a sample mixture, and incubating the sample mixture. The housing 410 also includes a top wall 424 and a port 426 extending through the top wall 424 to the interior chamber 422. The port 426 may permit a stain dispenser (not shown) to deliver the staining agent to the interior chamber 422, and/or may permit a sample dispenser (not shown) to deliver the sample to the interior chamber 422 so as to be added to the staining agent.

In some embodiments, the housing 410 may comprise a metallic material having relatively high thermal conductivity, such as aluminum, in order to promote uniform heating of the housing 410 and likewise uniform heating of the contents of the interior chamber 422. In the embodiment shown, the sidewalls 420 of the housing 410 are laminated with respective ferromagnetic sheets 412 to improve the efficiency of the heating (e.g., resistive heating, or alternatively inductive heating) performed by staining module 400 (e.g., due to the relatively low ferromagnetic properties of aluminum). More particularly, each ferromagnetic sheet 412 is secured to the outer surfaces of a corresponding pair of sidewalls 420. It will be appreciated that any suitable number of ferromagnetic sheets 412 may be used to laminate the sidewalls 420. In the embodiment shown, a thermally conductive compound 430 is deposited on the outer surfaces of the sidewalls 420 for adhering the ferromagnetic sheets 412 to the sidewalls 420. As best shown in FIG. 6B, an adhesive tape 432 is tightly wrapped about the ferromagnetic sheets 412 to securely engage the inner surfaces of the ferromagnetic sheets 412 with the outer surfaces of the sidewalls 420.

As best shown in FIG. 6C, the heating coil 414 includes a wire 440 wound about the sidewalls 420 of the housing 410 (and about ferromagnetic sheets 412). The wire 440 may comprise a metallic material having relatively high electrical conductivity, such as copper. The wire 440 may have any suitable cross-sectional area and/or thickness, and may be wound to define any suitable number of turns for the heating coil 414. The heating coil 414 in one embodiment functions as an inductor or induction coil, and is operatively coupled to a power unit 450, which may be configured to drive the heating coil 414 to a frequency at which the heating coil 414 behaves as a resonant circuit that under excitation produces an alternating current thereby producing an alternating magnetic field at or near the heating coil 414. This field may generate an electromagnetic field (EMF) on the outer surfaces of the sidewalls 420, which may in turn cause an alternating current. This current, in conjunction with the resistivity of the housing 410, may yield power dissipation and heat up the outer surfaces of the sidewalls 420. Such heat may be transferred to the contents of the chamber 422, such as the staining agent and/or the sample. It will be appreciated that such induction heating may be performed using relatively low input power, and/or may achieve homogeneous heating of the contents of the chamber 422 and thereby improve staining and/or lysing performance. In this regard, exciting the circuit at the resonant frequency may deliver maximum power, and exciting the circuit at an increasing frequency may effectively adjust the power delivery. Alternative embodiments can utilize a resistive heater/resistance heating coil for heater coil 414.

In some embodiments, a temperature sensor such as a thermistor (not shown) may be configured to continuously sense the temperature of the contents of the chamber 422. The temperature sensor may be configured to send feedback signals indicative of the sensed temperatures to a controller (not shown) which may in turn be configured to send control signals to the power unit 450 for selectively driving the heating coil 414. In this manner, the controller may cease heating of the contents of the chamber 422 upon reaching a threshold temperature. In one example, the controller utilizes heating control algorithms and the feedback signals are incorporated into elements of the algorithms or computer-driven instructions provided to the power unit 450 and/or heating coil 414 to optimally regulate temperature. In some embodiments, the controller may be configured to send control signals to a maintenance heater (not shown) for maintaining the contents of the chamber 422 at the threshold temperature.

In one embodiment, a plurality of staining modules are contemplated, each utilizing the structure of FIGS. 6A-6C (i.e., a plurality of structural elements 400). In this way, a plurality of samples can be stained, incubated, or otherwise prepared at a similar time. In one example, each staining module has its own unique heating element. In one example a staining module has a plurality of chambers 422, each capable of receiving a sample, and a common heating structure connected to the entire module (e.g., a single housing 410 with a plurality of chambers 422 and a common heating coil 414 surrounding housing 410).

### B. Example of Multi-Chamber Staining Module

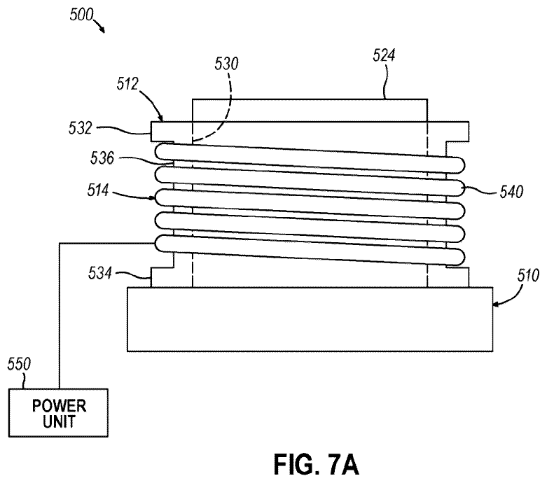

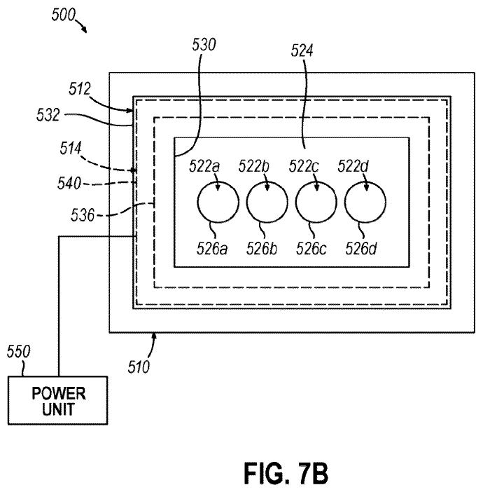

In a system such as shown in FIG. 1 or FIG. 2, a multi-chamber staining module (also referred to as a staining device) 500 such as shown in FIGS. 7A and 7B may be used to both mix a sample with a staining agent and incubate the sample mixture via induction heating prior to the cells within the sample mixture being imaged by a camera such as the high optical resolution imaging device 24 of FIG. 1, or the image sensor 210 of FIG. 2. For example, the staining module 500 may be incorporated in place of the source 25 shown in FIG. 1 or between the source 25 and the sample feed tube 29 shown in FIG. 1, to facilitate mixing of the sample with the staining agent and incubation of the sample mixture prior to capturing of images of the sample by the high optical resolution imaging device 24. The staining agent may include any suitable composition. For example, the staining agent may be composed in accordance with any one or more teachings of U.S. Pat. No. 9,279,750, entitled “Method and Composition for Staining and Sample Processing,” issued on Mar. 8, 2016, the disclosure of which is hereby incorporated by reference in its entirety; and/or U.S. Pat. No. 9,322,753, entitled “Method and Composition for Staining and Processing a Urine Sample,” issued on Apr. 26, 2016, the disclosure of which is hereby incorporated by reference in its entirety; and/or US Pub. No. 2021/0108994, entitled “Method and Composition for Staining and Sample Processing,” published on Apr. 15, 2021, the disclosure of which is hereby incorporated by reference in its entirety. Note, these staining agents generally describe a staining agent that contains a lysing agent to lyse red blood cells, a permeating agent to permeate white blood cells, a staining element to stain the interior content of white blood cells, and a repair element to repair the white blood cells so stain does not escape.

In the embodiment shown, the staining module 500 includes a housing 510, a bracket (also referred to as a sleeve) 512, and a heater in the form of a heating coil 514. The housing 510 includes a plurality of interior chambers 522a, 522b, 522c, 522d (also referred to as a sample reservoirs) for receiving the staining agent and the sample, mixing the staining agent and the sample to form a sample mixture, and incubating the sample mixture. The housing 510 also includes a top wall 524 and a plurality of ports 526a, 526b, 526c, 526d extending through the top wall 524 to corresponding interior chambers 522a, 522b, 522c, 522d. The ports 526a, 526b, 526c, 526d may permit a stain dispenser (not shown) to deliver the staining agent to the corresponding interior chambers 522a, 522b, 522c, 522d, and/or may permit a sample dispenser (not shown) to deliver the sample to the corresponding interior chambers 522a, 522b, 522c, 522d so as to be added to the staining agent. While four interior chambers 522a, 522b, 522c, 522d and corresponding ports 526a, 526b, 526c, 526d are shown, it will be appreciated that any suitable number of interior chambers 522a, 522b, 522c, 522d and corresponding ports 526a, 526b, 526c, 526d, such as two, three, or more than four interior chambers 522a, 522b, 522c, 522d and corresponding ports 526a, 526b, 526c, 526d. In some versions, the first and second interior chambers 522a, 522b may be configured for use as white blood cell (WBC) chambers 522a, 522b, while the third interior chamber 522c may be configured for use as a red blood cell (RBC) chamber 522c.

In some embodiments, the housing 510 may comprise a metallic material having relatively high thermal conductivity, such as aluminum, in order to promote uniform heating of the housing 510 and likewise uniform heating of the contents of the interior chambers 522a, 522b, 522c, 522d.

In the embodiment shown, a bracket or sleeve 512 is positioned around the housing 510. The bracket 512 includes an inner bore 530 that is sized and configured to receive at least a portion of the housing 510. In some embodiments, the inner bore 530 may be sized and configured to slidably receive the portion of the housing 510 such that the portion of the housing 510 may be selectively inserted into and/or removed from the inner bore 530. Bracket 512 also includes upper and lower lips 532, 534 defining a recessed region 536 therebetween. The recessed region 536 is sized and configured to accommodate at least a portion of the heating coil 514.

The heating coil 514 includes a wire 540 wound about bracket 512 on the recessed region 536. The wire 540 may comprise a metallic material having relatively high electrical conductivity, such as copper. The wire 540 may have any suitable cross-sectional area and/or thickness, and may be wound to define any suitable number of turns for the heating coil 514. The heating coil 514 is operatively coupled to a power unit 550, which may be configured to drive the heating coil 514 to a frequency at which the heating coil 514 behaves as a resonant circuit that under excitation produces an alternating current thereby producing an alternating magnetic field at or near the heating coil 514, in this way heating coil 514 can act as an inductor and configured as an inductive coil or an inductive heating coil. This field may generate an electromagnetic field (EMF) on the outer surfaces of the housing 510, which may in turn cause an alternating current. This current, in conjunction with the resistivity of the housing 510, may yield power dissipation and heat up the outer surfaces of the housing 510. Such heat may be transferred to the contents of one or more chambers 522a, 522b, 522c, 522d, such as the staining agent and/or the sample. It will be appreciated that such induction heating may be performed using relatively low input power, and/or may achieve homogeneous heating of the contents of one or more chambers 522a, 522b, 522c, 522d and thereby improve staining and/or lysing performance. In this regard, exciting the circuit at the resonant frequency may deliver maximum power, and exciting the circuit at an increasing frequency may effectively adjust the power delivery.

In some embodiments, bracket or sleeve 512 is composed of a conductive material (e.g., metallic material such as aluminum) to augment heat transfer to the housing and interior surface which receives the blood sample and stain. In some embodiments, bracket or sleeve 512 is composed of a ferromagnetic material. In some embodiments, the bracket or sleeve 512 is not utilized and instead heater/heater coil 514 is mounted directly to an external surface of housing 510.

In some embodiments, a temperature sensor such as a thermistor (not shown) may be configured to continuously sense the temperature of the contents of one or more chambers 522a, 522b, 522c, 522d. The temperature sensor may be configured to send feedback signals indicative of the sensed temperatures to a controller (not shown) which may in turn be configured to send control signals to the power unit 550 for selectively driving the heating coil 514. In this manner, the controller may cease heating of the contents of the chamber 522 upon reaching a threshold temperature. In some embodiments, the controller may be configured to send control signals to a maintenance heater (not shown) for maintaining the contents of one or more chambers 522a, 522b, 522c, 522d at the threshold temperature.

### C. Example of Sample Preparation Process

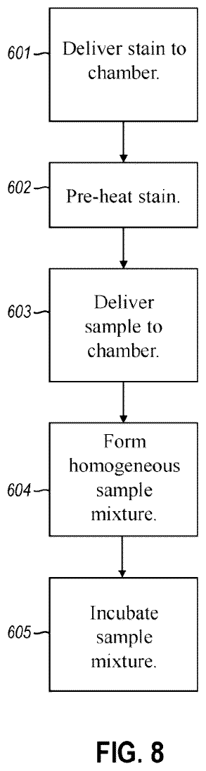

In a system such as shown in FIG. 1 or FIG. 2, a process such as shown in FIG. 8 may be used to perform sample preparation prior to the cells being imaged by a camera such as the high optical resolution imaging device 24 of FIG. 1, or the image sensor 210 of FIG. 2. Initially, in the process of FIG. 8, the staining agent may be delivered to a chamber, such as the chamber 422 of the staining module 400 shown in FIGS. 6A-6C or one or both WBC chambers 522a, 522b of the staining module 500 shown in FIGS. 7A-7B, at step 601. This may comprise, for example, delivering the staining agent to the chamber 422, 522a, 522b through the corresponding port 426, 526a, 526b via a stain dispenser. The staining agent may then be pre-heated within the chamber 422, 522a, 522b such as via induction heating, at step 602. Next, the sample may be delivered to the chamber 422, 522a, 522b at step 603. This may comprise, for example, delivering the sample to the chamber 422, 522a, 522b through the corresponding port 426, 526a, 526b via a sample dispenser so as to be added to the staining agent. In some embodiments, the delivery of the sample to the chamber 422, 522a, 522b may include mixing of the sample with the pre-heated stain within the chamber 422, 522a, 522b. In the process of FIG. 8, a homogeneous sample mixture may then be formed within the chamber 422, 522a, 522b at step 604. This may comprise, for example, using fluid energy to mix the sample with the stain, such as by cyclically pulling the sample out of and pushing the sample back into the chamber 422, 522a, 522b via a corresponding tangential port of the housing 410, 510 to perform a regurgitative mixing. Alternatively, this may comprise using a magnet to drive a spherical ferromagnetic ball placed within the chamber 422, 522a, 522b to perform an agitative mixing. As another example, this may comprise introducing one or more bubbles at a bottom of the chamber 422, 522a, 522b to create a vortex.

The homogenous sample mixture may then be heated within the chamber 422, 522a, 522b, such as via induction heating or resistive heating, at step 605. In some embodiments, the homogeneous sample mixture may be heated to a threshold temperature via induction heating or resistive heating, and may then be maintained at the threshold temperature via a maintenance heater. In embodiments using the multi-chamber staining module 500, it will be appreciated that sample mixtures within both WBC chambers 522a, 522b may be heated simultaneously via the induction heating, and that any sample within the RBC chamber 522c may also be heated via the induction heating (even though such heating of the sample within the RBC chamber 522c may not be required prior to imaging), while the fourth chamber 522d may remain empty. In some other embodiments using the multi-chamber staining module 500, one or more chambers 522a, 522b, 522c, 522d, such as the first WBC chamber 522a, may be used for heating a sample mixture while one or more of the other chambers 522a, 522b, 522c, 522d, such as the RBC chamber 522c, is simultaneously being rinsed; in such cases, increased power may be provided to the heating coil 540 in order to counteract any cooling effect that the rinsing of the RBC chamber 522c might otherwise have on the heating of the sample mixture within the first WBC chamber 522a (e.g., by adding the same amount of energy lost by such cooling effect).

After the homogenous sample mixture reaches the threshold temperature, the sample mixture may be conveyed to a flowcell, such as the flow cell 22 of FIG. 1 for being imaged by a camera such as the high optical resolution imaging device 24 of FIG. 1. For example, the homogeneous sample mixture may be conveyed directly from the chamber 422, 522a, 522b to the flow cell 22 (e.g., without undergoing further preparation). It will be appreciated that by heating the sample mixture in the same chamber 422, 522a, 522b as that in which the sample mixture is formed may improve the throughput of the staining process.

While the formation and induction heating of the sample mixture has been described as occurring within the chamber 422, 522 of the housing 410, 510, it will be appreciated that alternative arrangements may include a tubing having a lumen (not shown) in which the sample mixture may be formed and induction heated in manners similar to those described above. In addition, or alternatively, any one or more of the teachings herein may be combined with any one or more of the teachings disclosed in U.S. Pat. No. 9,429,524, entitled “Systems and Methods for Imaging Fluid Samples,” issued on Aug. 30, 2016, the disclosure of which is hereby incorporated by reference in its entirety.

In some embodiments, the addition of diluent is part of the preparation step, where the diluent is added to each chamber 522a-522d during before, after, or both before and after a blood sample is added to each chamber. For example, an RBC chamber can receive diluent as the primary or sole preparation reagent, while a WBC chamber can receive both diluent and stain.

It should be appreciated that the preparation step for RBC chambers can be different than WBC chambers. For instance, the RBC chambers would utilize a preparation step involving: a) receiving a diluent followed by a blood sample, b) receiving a blood sample followed by a diluent, or c) receiving a diluent, followed by a blood sample, followed by additional diluent; but would not receive a stain. In this way, the preparation time for the RBC chambers may be shorter and a workflow can involve running an RBC sample through an imaging process while the WBC samples are still being prepared.

In some embodiments, a staining reagent utilizes both a lysing agent (to lyse red blood cells) and a staining agent (to permeate the remaining white blood cells, stain the interior region, and repair the white blood cell so stain does not escape). In this way, a single staining reagent can be used to process certain types of cells (e.g., white blood cells) to both eliminate red blood cells and stain the remaining white blood cells. Other embodiments can utilize a plurality of compositions, for instance a first lysing reagent to lyse red blood cells, and a second staining reagent to stain white blood cells, where a workflow would involve a chamber (e.g., a WBC chamber) receiving a separate lysing reagent and a separate staining reagent to prepare WBC samples for visualization.

In some embodiments, the various chambers (e.g., 522a-522d) are not meant to strictly prepare dedicated cell types, or in other words can rotate cell types. For instance, the chambers can alternate being used for RBC and WBC preparation. In this manner, once the samples in the chambers are prepped an image, a cleaning cycle can be utilized to clean the chambers before receiving a subsequent blood sample (e.g., chamber 522a can first be configured to prepare WBC's for a certain amount of same preparation runs, then RBC's for a certain amount of sample preparation runs—for instance 1 WBC preparation followed by 1 RBC preparation, or 2 WBC preparations followed by 1 RBC preparation followed by 2 more WBC preparations, etc). A cleaning reagent, such as diluent or cleaner, can be used between sample runs to eliminate carryover. Even in circumstances where a particular chamber is solely used for a particular cell type (e.g., 522a used solely as a WBC chamber), there can be a cleaning step run after a sample is prepared and imaged in order to eliminate carryover.

Other embodiments can still utilize multiple stains as part of the preparation process. For instance, a first stain configured to stain white blood cells in the manner described herein, and a second stain configured to stain at least one of platelets or reticulocytes. These staining compositions can be used uniquely in various workflows. For instance, a first chamber of housing 410, 510 can be used to prepare a white blood cell sample that comprises receiving at least a WBC stain and lyse reagent, while a second chamber of housing 410, 510 can be used to prepare a platelet sample—this chamber would receive at least a platelet reagent—different than the WBC stain and lyse reagent.

Please note, though the term White blood cell (WBC) chamber and Red blood cell (RBC) chamber is used to denote the sample preparation chambers for imaging, the samples imaged as a result of the preparation process can allow for biological imaging of a plurality of cell types. For instance, the WBC chambers utilize a lyse to eliminate red blood cells, however the lyse may still retain platelets and reticulocytes, so the sample prepared in the WBC chamber can still image at least white blood cells, platelets, and reticulocytes—for instance. Similarly, the RBC chambers may receive a different preparation procedure than the WBC chambers (e.g., no lyse, or no stain/lyse combined reagent), but the sample prepared in the RBC chamber can still visualize a plurality of cell types, such as red blood cells—and one or more of white blood cells, platelets, and reticulocytes.

Additional information on lighting and staining modules can be found in U.S. patent application Ser. Nos. 18/224,937, 18/224,947, 18/224,953, the contents of which are hereby incorporated by reference in their entirety.

### IV. Examples of Maturity Determination

The system of FIG. 1 OR FIG. 2 generally illustrates an imaging system for obtaining images of particles (e.g., blood cells). For certain cells such as reticulocytes and platelets, these cells start as immature versions with relatively high RNA content. Being able to quantify cell maturity, for instance quantifying immature platelets or immature reticulocytes, can offer detailed information about patient health and therefore can be valuable. In some embodiments herein, image analysis techniques can be utilized to analyze images of cell types and, for example, analyze a nuclear region of a cell to correlate to an RNA content assessment and classify or quantity a cell maturity (e.g., identify a cell as an immature platelet or immature reticulocyte, and identify the number of such cells in a blood sample). These techniques can be used to generally identify and/or enumerate immature cells in a blood sample (e.g., not only immature platelets or immature reticulocytes), in various embodiments.

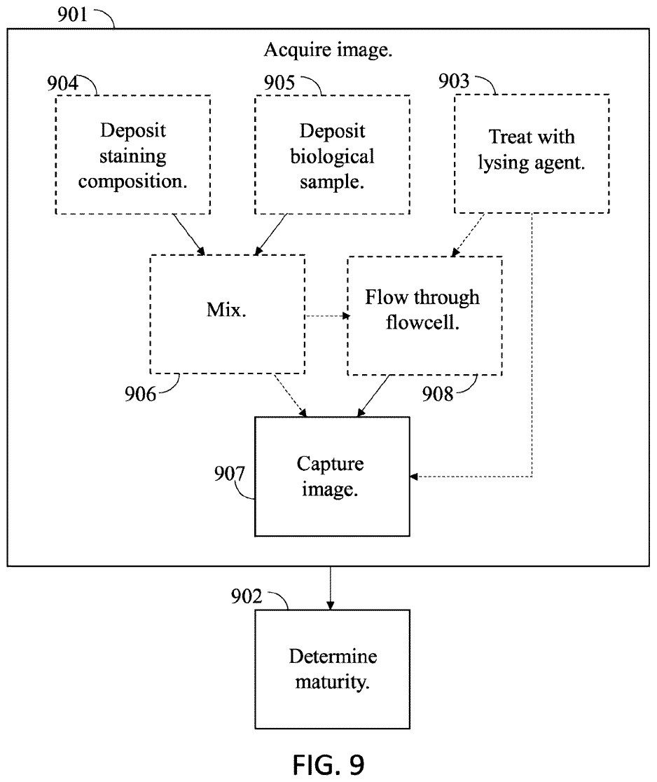

In a system such as shown in FIG. 1 or FIG. 2, the maturity of particles in a sample may be determined using a process which acquires an image of a particle and then uses that image to determine its maturity. An illustration of such a process is provided in FIG. 9, which not only illustrates acquiring 901 an image of a particle and determining 902 its maturity, but also illustrates certain acts which may be performed in image acquisition. As illustrated in FIG. 9, this may optionally include one or more sample preparation steps. These may include, for example, treating 903 the sample with a lysing agent which would remove one or more classes of particles which were not of interest. For instance, if the sample was a blood sample and the process of FIG. 9 was used to determine the maturity of reticulocytes or platelets in the sample, then the sample may be treated 903 with a lysing agent (e.g., a saponin) which would destroy mature red blood cells in the sample. Alternatively (or additionally), sample preparation may include depositing 904 a staining composition (e.g., New Methylene Blue (NMB) which would stain RNA inside cells in the sample and therefore could distinguish immature platelets and reticulocytes, which would have relatively more RNA than mature platelets or reticulocytes) and depositing 905 the sample into a chamber where they would be mixed 906. In embodiments where these types of preparation steps are performed, after the sample is prepared, an image of a stained blood cell may be captured 907. This image capture 907 may take place in the context of additional activities, such as flowing 98 the sample through a flowcell (e.g., when using a flow imaging system such as shown in FIG. 1).

It should be noted that, while FIG. 9 depicts sample preparation steps which may be performed in some embodiments, those steps and their depiction in FIG. 9 are intended to be illustrative only, and are not intended to imply limitations on how sample preparation may be performed (in embodiments where it is performed at all). For example, while FIG. 9 illustrated lysing and staining as essentially separate processes, in some cases a single composition can include both a lysing ingredient to lyse mature red blood cells, and a staining composition to stain the remaining cells. For example, step 904 can comprise depositing a composition containing both a lysing compound (e.g., saponin) and a staining compound (e.g., New Methylene Blue) as a single step. In some examples, multiple reagents or compositions may be used (e.g., a lyse composition, and a separate staining composition added after the lyse composition). It is also possible that different steps illustrated in FIG. 9 may be performed in different orders, for instance, by depositing 905 a biological sample simultaneously with, before, or after, depositing 904 a staining composition. Similarly, in some embodiments, preparation may involve only staining the blood sample and not lysing the blood sample, that is leaving the mature red blood cells intact. Descriptions of stain and stain/lysing compounds can be found in U.S. Pat. No. 9,279,750 and US. Publication No. 2021/0108994, the contents of which are hereby incorporated by reference in their entirety.

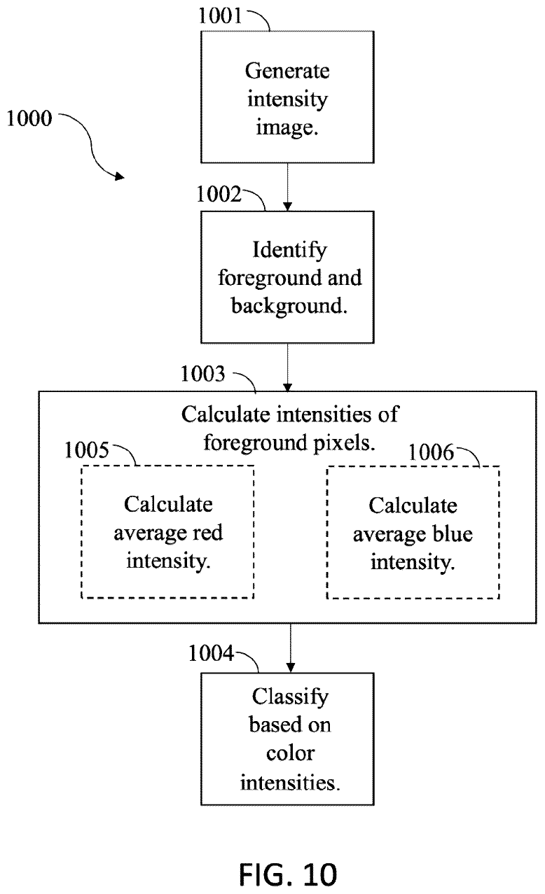

However image acquisition 901 is performed (e.g., via flow imaging as shown in FIG. 1 or slide imaging as shown in FIG. 2), once an image depicting a blood cell had been captured, that image may be used to determine 902 the cell's maturity. This may include, for example, classifying 1000 the depicted cell, such as using a method which performs classifications based on morphological features. When this type of classification is performed, cells whose maturity is not of interest may be identified and the maturity determination may not be completed for those cells (though data regarding those cells may be retained for other purposes). For example, in a case where a blood sample is expected to include white blood cells, platelets and reticulocytes (e.g., because mature red blood cells had been removed through treatment with a lysing agent), and where maturity determinations are made in order to calculate immature platelet and reticulocyte fractions, maturity determinations may be omitted for cells which are classified as white blood cells, while the remaining cells may have their maturities determined based on their classifications as reticulocytes or platelets. An illustration of how this type of classification 1000 could be made based on morphological features is set forth below in the context of FIG. 10.

Initially, in the method of FIG. 10, an intensity image would be generated 1001 based on the image captured by the system. In particular, the intensity image comprises the pixels of the image captured by the system and associates each of these pixels with a respective intensity associated therewith. For example, if a system were configured to capture RGB images, then the intensity image may be generated 1001 by associating to each pixel of the image captured by the system the average value of the R, G and B color channels of said each pixel.

Following step 1001, foreground and background portions could be identified 1002 in these intensity images. This may be done, for example, by thresholding, in which the darker pixels representing a blood cell would be separated from lighter pixels representing the background—for instance, by thresholding at a particular intensity value where pixels exceeding the intensity value are classified as foreground and pixels falling below the intensity value are classified as background, or vice versa, depending on the encoding of intensity values. For instance, in some embodiments, each channel of each pixel of the image captured by the system has a value between 0 and 255. In this case, for example, pixels associated with intensity greater than or equal to an intensity value equal to about 204 are considered to belong to the foreground and pixels associated with intensity smaller than the intensity value equal to about 204 are considered to belong to the background. These intensity values may be dependent on conditions of the imaging system (these can include, by way of example: lighting conditions, quality of stain, camera imaging characteristics, cell speed as the cell images are captured). In some examples, a pixel intensity threshold can have various values depending on these system qualities, for instance a number within a range of about 170-230, 190-210, or 200-207.

With the foreground and background pixels identified, intensities could be calculated 1003 for the foreground pixels. This may be done, for example, by calculating 1005 the average red intensity and calculating 1006 the average blue intensity of the foreground pixels from the original RGB image. Other approaches to calculating 1003 intensities for foreground pixels are also possible, and may be used instead of, or in addition to, the RGB based calculation. For example, in a case where the image was encoded using the hue, saturation, value color model—i.e., HSV images—then calculating 1003 intensities may simply entail treating the V values from the pixels of an HSV image as the intensities. Accordingly, the description of calculating 1003 intensities should be understood as being illustrative only, and should not be treated as limiting.

Once calculated 1003, the intensities could then be used to classify 1004 the type of imaged cell. For example, a picture could be treated as depicting a white blood cell (e.g., denoted as WBC) if the average intensity of the red color channels for its foreground pixels (e.g., denoted as MASK_R_MEAN) was less than a particular white blood cell (WBC) red color channel intensity cutoff value, and the average intensity of the blue color channels for its foreground pixels (e.g., denoted as MASK_B_MEAN) was less than a particular white blood cell (WBC) blue color channel intensity cutoff value. Similar approaches could be taken when identifying other types of cells, such as platelets and reticulocytes, though more complicated classifications are also possible. For example, in some cases, rather than simply comparing foreground pixel red color channel average intensity (e.g., denoted as MASK_R_MEAN) and foreground pixel blue color channel average intensity (e.g., denoted as MASK_B_MEAN) to cutoffs, classification may include one or more of: (i) comparing foreground pixel red color channel average intensity (e.g., denoted as MASK_R_MEAN) to foreground pixel blue color channel average intensity (e.g., denoted as MASK_B_MEAN), (ii) comparing a function of foreground pixel red color channel average intensity (e.g., denoted as MASK_R_MEAN) to a function of foreground pixel blue color channel average intensity (e.g., denoted as MASK_B_MEAN), and/or (iii) comparing a function of foreground pixel red color channel average intensity (e.g., denoted as MASK_R_MEAN) and of the foreground pixel blue color channel average intensity (e.g., denoted as MASK_B_MEAN) to a cutoff value.

To illustrate classification 1004 in the method of FIG. 10, WBC, platelet and reticulocyte classification criteria for images captured using a blood cell imaging analysis device (in one example a blood cell imaging analysis device utilizing flow imaging where the cells are imaged as they proceed past a camera in a flowcell and thresholded with an intensity value used for separating foreground from background pixels (e.g., by a thresholding value of about 204)) are set forth below in table 1. For the purposes of the table below, MASK_B_MEAN refers to a foreground pixel blue color channel average intensity, and MASK_R_MEAN refers to a foreground pixel red color channel average intensity.

TABLE 1
Exemplary classification criteria

| Cell Type | Classification Criteria |
|---|---|
| White blood | MASK_B_MEAN < 180 AND |
| cell/WBC | MASK_R_MEAN < 160 |
| Platelet | (MASK_B_MEAN − 150)/55 < |
| | (MASK_R_MEAN − 100)/100 AND |
| | MASK_R_MEAN >= 160 |
| Reticulocyte | (MASK_B_MEAN − 150)/55 < |
| | (MASK_R_MEAN − 100)/100 AND |
| | MASK_B_MEAN >= 180 |

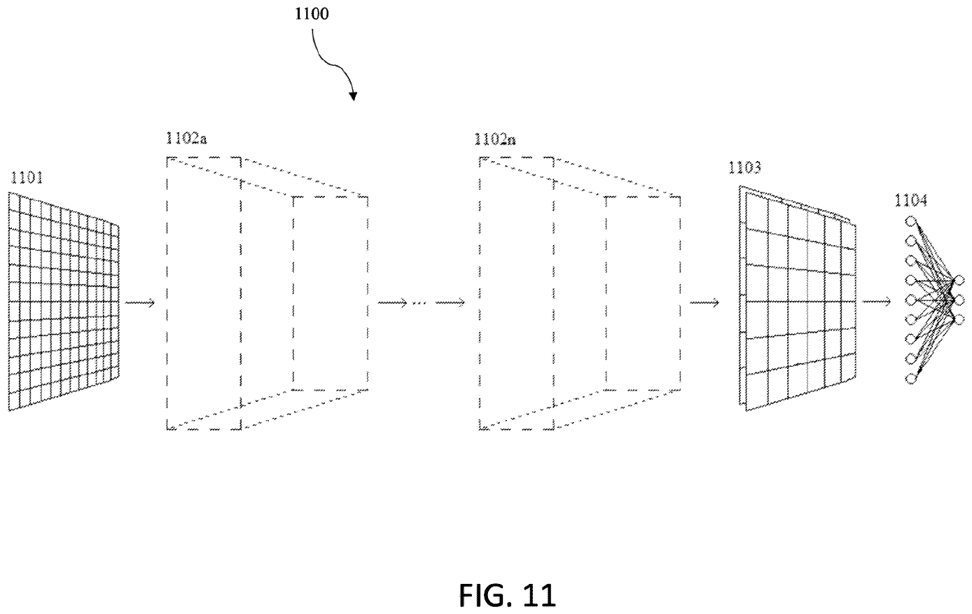

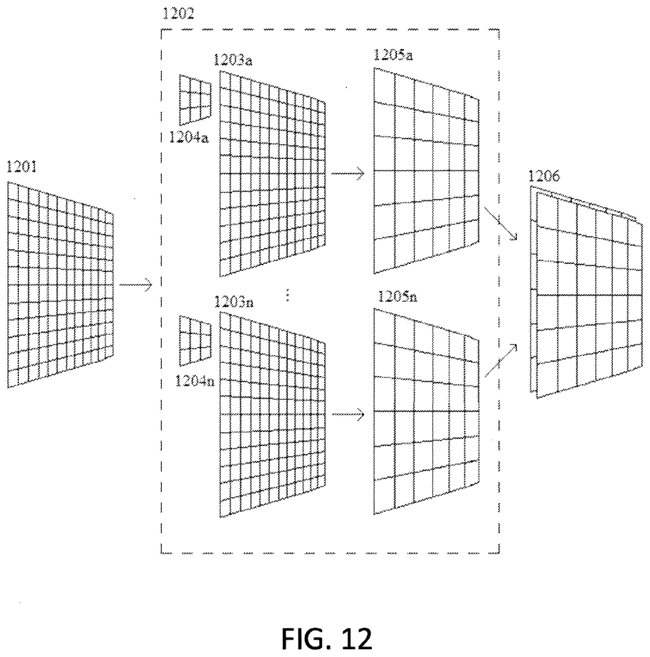

It should be understood that the classification criteria of table 1 (as well as the threshold value for separating 1003 the foreground from the background) are intended to be exemplary only. In embodiments where cells are classified 1000, different approaches may be used to implement that classification other than the approach described above in the context of FIG. 10. For example, rather than using the morphology based classification described in the context of FIG. 10, some embodiments may classify 1000 cells using a machine learning model. An example of such a machine learning model is shown in FIG. 11. When using the model 1100 of FIG. 11, an input image 1101 would be analyzed in a series of stages 1102a-1102n, each of which may be referred to as a “layer,” and which is illustrated in more detail in FIG. 12. As shown in FIG. 12, an input 1201 (which, in the initial layer 1102a of FIG. 11 would be the input image 1101, and otherwise would be the output of the preceding layer) is provided to a layer 1202 where it would be processed to generate one or more transformed images 1203a-1203n. This processing may include convolving the input 1201 with a set of filters 1204a-1204n, each of which would identify a type of feature from the underlying image that would then be captured in that filter's corresponding transformed image. For instance, as a simple example, convolving an image with the filter shown in table 2 could generate a transformed image capturing the edges from the input image 1201.

T
[ −1 −1 −1 ]
[ −1 8 −1 ]
[ −1 −1 −1 ]

As shown in FIG. 12, in addition to generating transformed images 1203a-1203n a layer may also generate a pooled image 1205a-1205n for each of the transformed images 1203a-1203n. This may be done, for example, by organizing the appropriate transformed image into a set of regions, and then replacing the values in each of the regions with a single value, such as the maximum value for the region or the average of the values for the region. The result would be a pooled image whose resolution would be reduced relative to its corresponding transformed image based on the size of the regions it was split into (e.g., if the transformed image had N×N dimensions, and it was split into 2×2 regions, then the pooled image would have size (N/2)×(N/2)). These pooled images 1205a-1205n could then be combined into a single output image 1206, in which each of the pooled images 1205a-1205n is treated as a separate channel in the output image 1206. This output image 1206 can then be provided as input to the next layer as shown in FIG. 11.

Returning to the discussion of FIG. 11, after a final output image 1103 has been created through the various stages 1102a-1102n of processing, the final output image 1103 could be provided as input to a neural network 1104. This may be done, for example, by providing the value of each channel of each pixel in the output image 1103 to an input node of a densely connected single layer network. The output of the neural network 1104 could then be treated as a classification of the original input image 1101. For example, in the case such as shown in FIG. 11, where a neural network 1104 has multiple output nodes each of those output nodes may be treated as corresponding to a cell classification (e.g., one output node corresponding to WBCs, one output node corresponding to reticulocytes, and one output node corresponding to platelets), and the corresponding classification for the output node with the highest value could be treated as the classification for the cell depicted in the input image that resulted in that value being reached.

Machine learning models such as illustrated in FIGS. 11 and 12 can be trained to classify cells using blood cell images having known classes to minimize cross entropy loss among the output nodes of the neural network 1104. Such blood cell images can be acquired through human annotation of images produced during normal operation of an analyzer (e.g., a human inspecting images and then labeling them with cell classes), but they could also be acquired in other manners. For example, images may be classified using morphology based classification such as discussed above in the context of FIG. 10, and those classified images can then be used to train a machine learning model such as illustrated in FIGS. 11 and 12. This training may include splitting the classified images up multiple subsets, or folds, and then training and evaluating the model multiple times, with a different fold of training images being held back as a validation set each time (i.e., K-fold cross validation). In this way, performance metrics from each training instance can be averaged to verify the model's generalization performance and, assuming the performance is acceptable, a final trained version of the model (e.g., whichever trained model had the best individual performance) can be used to make inferences (i.e., classify cell images) in production. Additional types of machine learning models, such as models having a single output, are described inin patent cooperation treaty application PCT/US22/52702 filed Dec. 13, 2022, the disclosure of which is hereby incorporated by reference in its entirety, and may be used instead of the machine learning model of FIG. 11 (e.g., a single output machine learning model may be trained provide different output values for different types of cells (e.g., 0 for WBCs, 1 for reticulocytes, 2 for platelets) and whichever of those values was closest to the output value generated by the model based on a particular input image would be treated as the classification for the cell depicted in that input image). Similarly, other types of cell classification, such as those described in U.S. Pat. No. 11,403,751, which is incorporated herein in its entirety, may also be used. Accordingly, the discussion of use of machine learning models for classification set forth above in the context of FIGS. 11 and 12 should be understood as being illustrative only, and should not be treated as limiting.

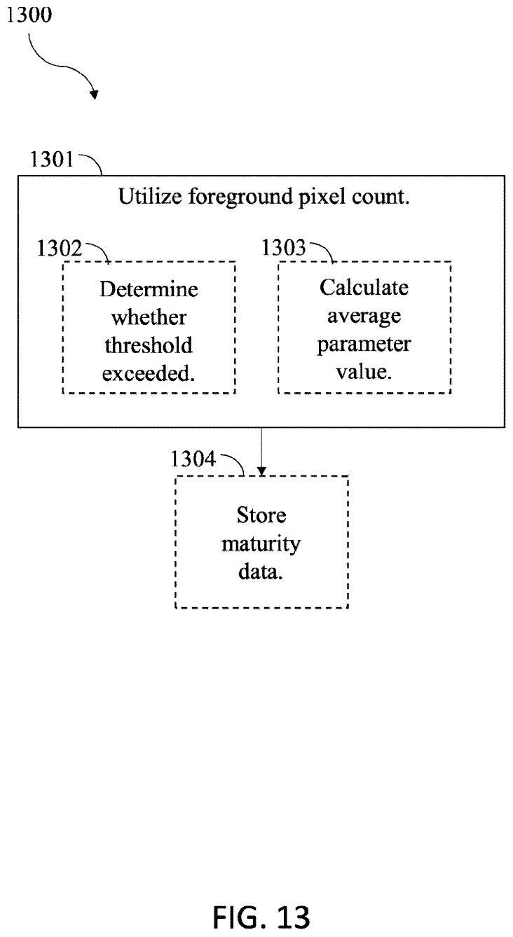

In embodiments which include classifying 1000 an imaged cell, after that classification is complete, a maturity may be generated for the imaged cell, such as using a method as shown in FIG. 13. As shown in FIG. 13, generating 1300 a maturity for an imaged cell may include utilizing 1301 a count of the pixels included in the foreground portion of the image. For example, in a case where maturity is being generated 1300 in order to calculate immature platelet fraction and immature reticulocyte fraction, utilizing 1301 the foreground pixel count may include determining 1302 whether the threshold pixel count is greater than a threshold value. If the number of pixels in the foreground of the image is above a pixel threshold, then the depicted cell may be classified as immature, while if the number of pixels is below the threshold it may be classified as mature. In embodiments which take this approach, the pixel threshold used in this determination 1302 may depend on how the cell for which the maturity was being generated was classified. For example, in images where individual pixels corresponded to squares with sides of length 0.14 μm, a threshold of 490 pixels may be used to separate immature from mature platelets, with images having platelets covering more than 490 pixels being treated as immature and images having platelets covering 490 or fewer pixels being treated as mature. Alternatively or additionally, in images captured using that same device, a threshold of 700 pixels may be used to separate immature from mature reticulocytes, with images having reticulocytes covering more than 700 pixels being treated as immature and images having reticulocytes covering 700 or fewer pixels being treated as mature. In images captured using equipment with different pixel sizes or for other types of cells of interest, different thresholds may be used, with the specific threshold to be used in a particular context being identified using methods known in the art, such as using a clustering algorithm to determine a best fit line separating labeled images of immature and mature cells of a particular type.

Other methods of utilizing 1301 a count of foreground pixels when generating 1300 a maturity for an imaged cell are also possible. For example, as illustrated in FIG. 13, the count of foreground pixels may be utilized 1301 in calculating 1303 an average parameter value for the cell. This type of approach may leverage the fact that the maturity of a cell may be correlated with a particular measurable parameter. For instance, because more immature reticulocytes or platelets tend to have more RNA than more mature reticulocytes or platelets—or in other words, with RNA content decreasing as these cells mature, a staining process may lead to measurable color differences correlated to (im)maturity (e.g., a more immature cell may tend to have bluer pixels than a less immature cell). Thus, the value of a color channel which is measurably different depending on immaturity could be averaged across the foreground pixels, thereby providing a maturity for the cell in terms of the average of that parameter (e.g., an average “blueness” value). Other variations, are also possible, and could be implemented by those of skill in the art without undue experimentation based on this disclosure. For example, rather than making a binary distinction between “mature” and “immature” or treating maturity as a value on a continuum as with a parameter average, a cell could be placed into one of a set of maturity buckets based on where an average parameter value (e.g., blueness) falls on a continuum of possible values. Similarly, in some cases, other approaches, such as calculating maturity based on the number of foreground pixels in a nucleus to the number of foreground pixels in the cell in question, based on a perimeter of a nucleus to an area of the cell in question, or based on a combination of two or more of the previously listed (or other) factors may also be used. Accordingly, the discussion of utilizing 1301 a foreground pixel count for a binary mature/immature classification should be understood as being illustrative only, and should not be treated as implying limitations on the protection provided by this document or any other document claiming the benefit of this document.

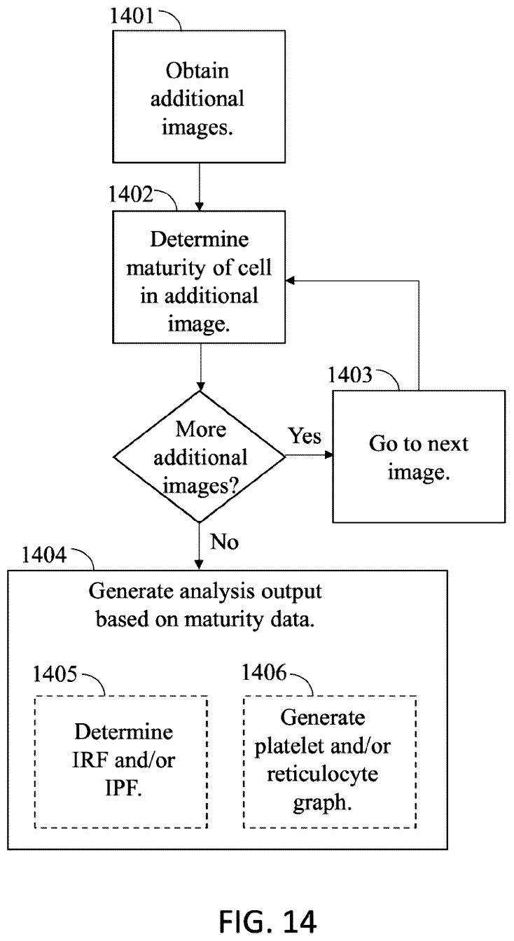

However it is generated, once it is available, maturity data for a cell depicted in an image under analysis may be stored 1304, such as for combining with maturity data for other cells to provide overall information for a biological sample. To illustrate, consider FIG. 14, which illustrates a method in which maturity information such as could be generated using the disclosed technology is used to generate overall information for a biological sample. When performing a method such as shown in FIG. 14, a plurality of additional images would be obtained 1401, such as through capturing images of additional cells included in a biological sample being analyzed. Once those additional images were obtained, the maturity of a cell depicted in one of those images may be determined 1402 (e.g., using the techniques described above as potentially being used in determining 902 maturity of a cell in the method of FIG. 9). The process could then proceed 1403 to the next image as long as there were pictures of cells whose maturity had yet to be determined. Finally, once maturity had been determined 1402 for all of the depicted cells of interest (e.g., platelets and reticulocytes) an analysis output could be generated 1404 based on the maturity data for those cells. As shown in FIG. 14, generating 1404 the analysis output may be performed in a variety of manners. For example, in a case where the disclosed technology is used to separate reticulocytes and/or platelets into categories of “mature” and “immature” then generating 1404 the analysis output may comprise determining 1405 at least one of an immature reticulocyte fraction (i.e., the number of reticulocytes classified as “immature” divided by the total number of reticulocytes, abbreviated IRF) and an immature platelet fraction (i.e., the number of platelets classified as “immature” divided by the total number of platelets, abbreviated IPF). Alternatively, in a case where the disclosed technology is used to generate maturity values along a continuum (e.g., using a factor average such as discussed previously in the context of FIG. 13) generating 1404 the analysis output may comprise generating 1406 a graph showing a distribution of maturity values for reticulocytes over a range of reticulocyte maturity values, and/or generating a graph showing a distribution of maturity values for platelets over a range of platelet maturity values. Other types of analysis outputs (e.g., histograms showing distributions of reticulocytes and/or platelets in cases where imaged cells are bucketed based on maturity) could also be generated 1404, and so the examples illustrated in FIG. 14 should not be treated as imposing limits on the types of outputs which could be generated by embodiments of the disclosed technology.

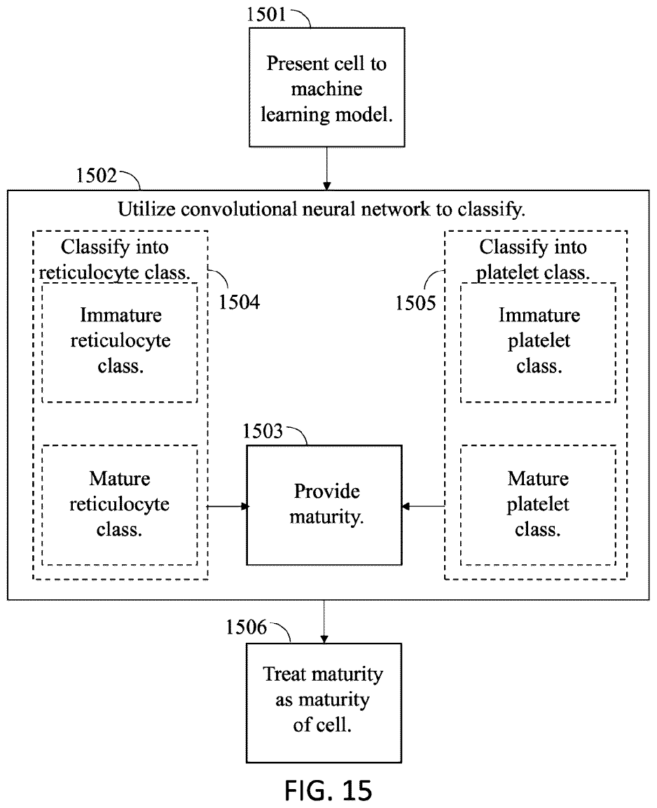

Variations are also possible in aspects other than types of outputs which can be generated based on maturity data. For example, while in some embodiments determining 902 maturity of a cell may comprise classifying 1000 the cell followed by generating 1300 a maturity for the cell, in other embodiments, determining 902 maturity of a cell may be performed without separate classification 1000 and generation 1300 steps. As an illustration of this, FIG. 15 depicts a method in which a maturity for a cell is created as part of classifying the cell. Initially, in that method, a cell would be presented 1501 to a machine learning model, such as by providing an image of the cell as input to a machine learning model comprising a convolutional neural network as shown FIGS. 11 and 12. The machine learning model could then utilize 1502 the convolutional neural network to classify the cell. The machine learning model may generate this classification in a manner similar to that discussed above in the context of FIGS. 11 and 12, but may also provide 1503 a maturity if the cell that was being classified was of a type whose maturity was of interest. For example, in a case where maturities were determined for reticulocytes and platelets, then when the cell is classified 1504 into a reticulocyte class and when the cell is classified 1505 into a platelet class, the machine learning model may also provide 1503 a maturity for the cell. This may be done by structuring a dense layer 1104 to include both a set of type nodes (e.g., a node corresponding to WBCs, a node corresponding to reticulocytes, and a node corresponding to platelets), as well as a maturity node which would be trained to provide maturities and which could be polled in the case where the type nodes indicated that the cell was a reticulocyte or a platelet. Alternatively, in a case where maturity would be a binary determination of mature or immature, the machine learning model may comprise not only a single platelet class and a single reticulocyte class, but may instead may included an immature reticulocyte class, a mature reticulocyte class, an immature platelet class and a mature platelet class, and which of the types of platelet/reticulocyte classes a cell was classified into may be treated as providing the cell's maturity.

However the maturity is provided 1503 in the method of FIG. 15, after a maturity had been provided 1503 by the machine learning model, the maturity from the model could be treated 1506 as the mature for the cell under analysis. For example, in a case where there was a separate maturity node in the dense layer 1104 of a machine learning model following the architecture of FIG. 11, the value on that output node may simply be treated 1506 as the maturity for the cell whose presentation 1501 to the machine learning model led to that value being generated. Alternatively, in a case where there were output nodes corresponding to immature reticulocytes, mature reticulocytes, immature platelets and mature platelets, then the cell could be treated 1506 as immature if it was classified into the immature platelet or immature reticulocyte class, or could be treated 1506 as mature if it was classified into the mature reticulocyte or mature platelet class. Accordingly, the discussion of embodiments in which the maturity for a cell would be generated 1300 after the cell is classified 1000 should be understood as being illustrative only, and should not be treated as limiting.

Other variations on potential implementations of the disclosed technology are also possible, and will be immediately apparent to those of skill in the art in light of this disclosure. For example, while a machine learning model such as shown in FIGS. 11 and 12 may simply take an image depicting a cell as input, it is also possible that other information may be provided as input to such a model. For instance, a model may be provided, either in addition to or as an alternative to a cell image, with derived information such as a number of foreground pixels, a ratio of a number of pixel in a nucleus to the number of pixels in the cell, and/or other parameter described herein as useful for determining maturity of a cell (whether as part of cell classification or otherwise). As another example, while a machine learning model (or other classification function, such as a morphology based function as described in the context of FIG. 10) may be designed to classify cells in samples which had previously been lysed to remove mature red blood cells (RBCs), it is also possible that the disclosed technology may be implemented to make classifications for samples where RBCs may be present (e.g., by adding an additional output node for RBCs to the dense layer 1104 of a machine learning model as shown in FIG. 11). Variations are also possible in terms of the physical devices which may be used in different implementations. For example, in some cases, analysis of images associated with the determination of maturities for depicted cells may be performed using processors which are local to a system such as the systems shown in FIGS. 1 and 2 which is used to capture the images themselves. However, in other cases, the analysis and collection of data may be separated, for example in a system where captured images are transmitted over a network connection to a remote processor which would analyze them and then send the results (e.g., analysis output generated 1404 as described in the context of FIG. 14) back to their source (or to another endpoint) for review.

Other applications are also possible. For example, while the above description focused on determining maturity, aspects of the disclosed technology may also be used for other types of analysis, such as detection of cells which are infected with malaria or other parasites. This is because infected cells, like immature platelets and reticulocytes, will have relatively more RNA, and therefore may be distinguishable from other cells using techniques similar to those described above for identifying maturity for reticulocytes and/or platelets (e.g., thresholding using a number of dark pixels in a cell image). As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A computer-implemented image analysis method for detecting maturity of a blood cell, comprising: depositing a staining composition into a chamber; depositing a biological sample into the chamber; mixing the biological sample and the staining composition in the chamber; capturing an image of a stained blood cell from the biological sample with a camera; and determining a maturity of the stained blood cell based on the image of the stained blood cell captured with the camera.

### Example 2

The image analysis method of example 1, wherein: the method further comprises: treating the biological sample with a lysing agent; and flowing the biological sample through a flowcell and past the camera; and capturing the image of the stained blood cell with the camera is performed while the biological sample is flowing through the flowcell and past the camera.

### Example 3

The image analysis method of example 2, wherein: determining the maturity of the stained blood cell comprises classifying the stained blood cell; and classifying the stained blood cell comprises classifying the stained blood cell as at least one of a reticulocyte or a platelet.

### Example 4

The image analysis method of example 3, wherein the method further comprises: obtaining a plurality of additional images, wherein each image from the plurality of additional images depicts an additional stained blood cell corresponding to that image; for each image from the plurality of additional images, determining the maturity of the additional stained blood cell corresponding to that image; and generating an analysis output based on a set of maturity data comprising the maturity of stained blood cell and the maturities of the stained blood cells depicted in the plurality of additional images.

### Example 5

The image analysis method of example 4, wherein generating the analysis output comprises determining at least one of an immature reticulocyte fraction and an immature platelet fraction for the biological sample.

### Example 6

The image analysis method of any one of examples 4 to 5, wherein generating the analysis output comprises generating at least one of: a graph showing a distribution of reticulocytes in the biological sample over a reticulocyte maturity range; and a graph showing a distribution of platelets in the biological sample over a platelet maturity range.

### Example 7

The image analysis method of any one of examples 3 to 6, wherein classifying the stained blood cell comprises utilizing a convolutional neural network.

### Example 8

The image analysis method of example 7, wherein: the convolutional neural network is comprised by a machine learning model configured to, when presented with an input stained blood cell: classify the input stained blood cell as a reticulocyte by classifying it into a reticulocyte class; when the input stained blood cell is classified into the reticulocyte class, providing a maturity for the input stained blood cell; classifying the input stained blood cell as a platelet by classifying it into a platelet class; and when the input stained blood cell is classified into the platelet class, providing the maturity for the input stained blood cell; and determining the maturity of the stained blood cell comprises: presenting the stained blood cell to the machine learning model as the input stained blood cell; and treating the maturity provided by the machine learning model as the maturity of the stained blood cell.

### Example 9

The image analysis method of example 8, wherein: the machine learning model is configured to classify the input stained blood cell into the platelet class and to, when the input stained blood cell is classified into the platelet class, provide the maturity for the input stained blood cell by classifying the input stained blood cell into a class selected from the group consisting of: an immature platelet class; and a mature platelet class; and the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of: an immature reticulocyte class; and a mature reticulocyte class.

### Example 10

The image analysis method of any of examples 3-7, wherein determining the maturity of the stained blood cell comprises generating the maturity of the stained blood cell after the stained blood cell is classified.

### Example 11

The image analysis method of any one of examples 3 to 7, wherein classifying the stained blood cell comprises identifying a foreground in the image based on an intensity of each pixel in the image.

### Example 12

The image analysis method of example 11, comprising: calculating: an average red intensity of pixels in the foreground of the image; and an average blue intensity of pixels in the foreground of the image; and classifying the stained blood cell based on the average red intensity and the average blue intensity.

### Example 13

The image analysis method of any one of examples 1-12, wherein determining the maturity of the stained blood cell comprises utilizing a pixel foreground count.

### Example 14

The image analysis method of any of examples 1-7 or 10-12, wherein determining the maturity of the stained blood cell comprises determining whether a pixel foreground count exceeds a threshold amount.

### Example 15

The image analysis method of any of examples 1-14, wherein the method comprises: pre-heating the staining composition in the chamber prior to depositing the biological sample in the chamber; and heating the biological sample and the staining composition in the chamber.

The image analysis method of example 15, wherein both pre-heating the staining composition in the chamber; and heating the biological sample and the staining composition in the chamber; comprise increasing chamber temperature using a heating coil.

### Example 16

### Example 17

The image analysis method of example 16, wherein the heating coil is mounted on a mounting bracket connected to the chamber and to one or more other mixing chambers.

### Example 18

A computer-implemented image analysis method for detecting maturity of a blood cell, comprising: flowing a biological sample through a flowcell and past a camera; capturing an image of a stained blood cell with the camera while the biological sample is flowing through the flowcell and past the camera; and determining a maturity of the stained blood cell based on the image of the stained blood cell captured with the camera.

### Example 19

The image analysis method of example 18, wherein the method further comprises treating the biological sample with a lysing agent.

### Example 20

The image analysis method of example 19, wherein: determining the maturity of the stained blood cell comprises classifying the stained blood cell; and classifying the stained blood cell comprises classifying the stained blood cell as at least one of a reticulocyte or a platelet.

### Example 21

The image analysis method of example 20, wherein the method further comprises: obtaining a plurality of additional images, wherein each image from the plurality of additional images depicts an additional stained blood cell corresponding to that image; for each image from the plurality of additional images, determining the maturity of the additional stained blood cell corresponding to that image; and generating an analysis output based on a set of maturity data comprising the maturity of stained blood cell and the maturities of the stained blood cells depicted in the plurality of additional images.

### Example 22

The image analysis method of example 21, wherein generating the analysis output comprises determining at least one of an immature reticulocyte fraction and an immature platelet fraction for the biological sample.

### Example 23

The image analysis method of any one of examples 21 to 22, wherein generating the analysis output comprises generating at least one of: a graph showing a distribution of reticulocytes in the biological sample over a reticulocyte maturity range; and a graph showing a distribution of platelets in the biological sample over a platelet maturity range.

### Example 24

The image analysis method of any one of examples 20 to 23, wherein classifying the stained blood cell comprises utilizing a convolutional neural network.

### Example 25

The image analysis method of example 24, wherein: the convolutional neural network is comprised by a machine learning model configured to, when presented with an input stained blood cell: classify the input stained blood cell as a reticulocyte by classifying it into a reticulocyte class; when the input stained blood cell is classified into the reticulocyte class, providing a maturity for the input stained blood cell; classifying the input stained blood cell as a platelet by classifying it into a platelet class; and when the input stained blood cell is classified into the platelet class, providing the maturity for the input stained blood cell; and determining the maturity of the stained blood cell comprises: presenting the stained blood cell to the machine learning model as the input stained blood cell; and treating the maturity provided by the machine learning model as the maturity of the stained blood cell.

### Example 26

The image analysis method of example 25, wherein: the machine learning model is configured to classify the input stained blood cell into the platelet class and to, when the input stained blood cell is classified into the platelet class, provide the maturity for the input stained blood cell by classifying the input stained blood cell into a class selected from the group consisting of: an immature platelet class; and a mature platelet class; and the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of: an immature reticulocyte class; and a mature reticulocyte class.

### Example 27

The image analysis method of any of examples 20-24, wherein determining the maturity of the stained blood cell comprises generating the maturity of the stained blood cell after the stained blood cell is classified.

### Example 28

The image analysis method of any one of examples 20-23, wherein classifying the stained blood cell comprises identifying a foreground in the image based on an intensity of each pixel in the image.

### Example 29

The image analysis method of example 28, further comprising: calculating: an average red intensity of pixels in the foreground of the image; and an average blue intensity of pixels in the foreground of the image; and classifying the stained blood cell based on the average red intensity and the average blue intensity.

### Example 30

The image analysis method of any one of examples 18-29, wherein determining the maturity of the stained blood cell comprises utilizing a pixel foreground count.

### Example 31

The image analysis method of any of examples 18-24 or 27-29, wherein determining the maturity of the stained blood cell comprises determining whether a pixel foreground count exceeds a threshold amount.

### Example 32

The image analysis method of any of examples 18-31, wherein the method comprises: depositing a staining composition into a chamber; depositing the biological sample into the chamber; and mixing the biological sample and the staining composition in the chamber.

### Example 33

The image analysis method of example 32, wherein the method further comprises: pre-heating the staining composition in the chamber prior to depositing the biological sample in the chamber; and heating the biological sample and the staining composition in the chamber.

### Example 34

The image analysis method of example 33, wherein both pre-heating the staining composition in the chamber; and heating the biological sample and the staining composition in the chamber; comprise increasing chamber temperature using a heating coil.

### Example 35

The image analysis method of example 34, wherein the heating coil is mounted on a mounting bracket connected to the chamber and to one or more other mixing chambers.

### Example 36

An image analysis system for detecting maturity of a blood cell comprising: one or more chambers configured to receive a biological sample and a staining composition; a camera configured to capture an image of a stained blood cell; and one or more processors configured to determine a maturity of the stained blood cell based on the image of the stained blood cell captured by the camera.

### Example 37

The image analysis system of example 36, wherein determining the maturity of the stained blood cell comprises classifying the stained blood cell as at least one of a reticulocyte or a platelet.

### Example 38

The image analysis system of example 37, wherein the one or more processors are further configured to: obtain a plurality of additional images, wherein each image from the plurality of additional images depicts an additional stained blood cell corresponding to that image; for each image from the plurality of additional images, determine the maturity of the additional stained blood cell corresponding to that image; and generate an analysis output based on a set of maturity data comprising the maturity of stained blood cell and the maturities of the stained blood cells depicted in the plurality of additional images.

### Example 39

The image analysis system of example 38, wherein generating the analysis output comprises determining at least one of an immature reticulocyte fraction and an immature platelet fraction for the biological sample.

### Example 40

The image analysis system of any one of examples 38 to 39, wherein generating the analysis output comprises generating at least one of: a graph showing a distribution of reticulocytes in the biological sample over a reticulocyte maturity range; and a graph showing a distribution of platelets in the biological sample over a platelet maturity range.

### Example 41

The system of any one of examples 37 to 40, wherein the one or more processors are configured to classify the stained blood cell utilizing a convolutional neural network.

### Example 42

The system of example 41, wherein: the convolutional neural network is comprised by a machine learning model configured to, when presented with an input stained blood cell: classify the input stained blood cell as a reticulocyte by classifying it into a reticulocyte class; when the input stained blood cell is classified into the reticulocyte class, providing a maturity for the input stained blood cell; classifying the input stained blood cell as a platelet by classifying it into a platelet class; and when the input stained blood cell is classified into the platelet class, providing the maturity for the input stained blood cell; and the one or more processors are configured to determine the maturity of the stained blood cell by performing acts comprising: presenting the stained blood cell to the machine learning model as the input stained blood cell; and treating the maturity provided by the machine learning model as the maturity of the stained blood cell.

### Example 43

The system of example 42, wherein: the machine learning model is configured to classify the input stained blood cell into the platelet class and to, when the input stained blood cell is classified into the platelet class, provide the maturity for the input stained blood cell by classifying the input stained blood cell into a class selected from the group consisting of: an immature platelet class; and a mature platelet class; and the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of: an immature reticulocyte class; and a mature reticulocyte class.

### Example 44

The system of any one of examples 37 to 41, wherein the one or more processors are configured to determine the maturity of the stained blood cell by performing acts comprising generating the maturity of the stained blood cell after the stained blood cell is classified.

### Example 45

The system of any of examples 37 to 41 or 44, wherein the one or more processors are configured to classify the stained blood cell based on identifying a foreground in the image based on an intensity of each pixel in the image.

### Example 46

The system of example 45, wherein: the one or more processors are further configured to calculate: an average red intensity of pixels in the foreground of the image; and an average blue intensity of pixels in the foreground of the image; and the one or more processors are configured to classify the stained blood cell based on the average red intensity and the average blue intensity.

The system of any one of examples 36-41 or 44-46, wherein the one or more processors are configured to determine the maturity of the stained blood cell based on a pixel foreground count.

### Example 47

### Example 48

The system of any one of examples 36-41 or 44-47, wherein the one or more processors are configured to determine that the stained blood cell is immature based on a pixel foreground count exceeding a threshold amount.

### Example 49

The system of any one of examples 36-48, wherein the one or more chambers are further configured to receive a lysing composition.

### Example 50

The system of any one of examples 36-48, wherein the staining composition further comprises a lysing compound.

### Example 51

The system of any one of examples 36-50 wherein the system further comprises a heater configured to heat the biological sample and the staining composition.

### Example 52

The system of example 51, wherein the heater comprises an induction coil.

### Example 53

The system of any one of examples 51 to 52, wherein the one or more chambers comprises two or more chambers, and the heater is linked to all of the two or more chambers.

### Example 54

The system of example 53, wherein the heater comprises a mounting bracket connected to all of the two or more chambers, and a heating element mounted to the mounting bracket.

### Example 55

An image analysis system for detecting maturity of cells in a biological sample comprising: a flowcell configured to flow stained cells therethrough; a camera configured to capture an image of a stained blood cell as the stained blood cell is flowing past the camera in an imaging region of the flowcell; and one or more processors configured to determine a maturity of the stained blood cell based on the image of the stained blood cell captured by the camera.

### Example 56

The image analysis system of example 55, wherein: determining the maturity of the stained blood cell comprises classifying the stained blood cell; and classifying the stained blood cell comprises classifying the stained blood cell as at least one of a reticulocyte or a platelet.

### Example 57

The image analysis system of example 56, wherein the one or more processors are configured to: obtain a plurality of additional images, wherein each image from the plurality of additional images depicts an additional stained blood cell corresponding to that image; for each image from the plurality of additional images, determine the maturity of the additional stained blood cell corresponding to that image; and generate an analysis output based on a set of maturity data comprising the maturity of stained blood cell and the maturities of the stained blood cells depicted in the plurality of additional images.

### Example 58

The image analysis system of example 57, wherein generating the analysis output comprises determining at least one of an immature reticulocyte fraction and an immature platelet fraction for the biological sample.

### Example 59

The image analysis system of any one of examples 57 to 58, wherein generating the analysis output comprises generating at least one of: a graph showing a distribution of reticulocytes in the biological sample over a reticulocyte maturity range; and a graph showing a distribution of platelets in the biological sample over a platelet maturity range.

### Example 60

The image analysis system of any one of examples 56 to 59, wherein classifying the stained blood cell comprises utilizing a convolutional neural network.

### Example 61

The image analysis system of example 60, wherein: the convolutional neural network is comprised by a machine learning model configured to, when presented with an input stained blood cell: classify the input stained blood cell as a reticulocyte by classifying it into a reticulocyte class; when the input stained blood cell is classified into the reticulocyte class, providing a maturity for the input stained blood cell; classifying the input stained blood cell as a platelet by classifying it into a platelet class; and when the input stained blood cell is classified into the platelet class, providing the maturity for the input stained blood cell; and determining the maturity of the stained blood cell comprises: presenting the stained blood cell to the machine learning model as the input stained blood cell; and treating the maturity provided by the machine learning model as the maturity of the stained blood cell.

### Example 62

The image analysis system of example 61, wherein: the machine learning model is configured to classify the input stained blood cell into the platelet class and to, when the input stained blood cell is classified into the platelet class, provide the maturity for the input stained blood cell by classifying the input stained blood cell into a class selected from the group consisting of: an immature platelet class; and a mature platelet class; and the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of: an immature reticulocyte class; and a mature reticulocyte class.

### Example 63

The image analysis system of any of examples 56-60, wherein determining the maturity of the stained blood cell comprises generating the maturity of the stained blood cell after the stained blood cell is classified.

### Example 64

The image analysis system of any one of examples 56-59, wherein classifying the stained blood cell comprises identifying a foreground in the image based on an intensity of each pixel in the image.

### Example 65

The image analysis system of example 64, further comprising: calculating: an average red intensity of pixels in the foreground of the image; and an average blue intensity of pixels in the foreground of the image; and classifying the stained blood cell based on the average red intensity and the average blue intensity.

### Example 66

The image analysis system of any one of examples 55-60, wherein determining the maturity of the stained blood cell comprises utilizing a pixel foreground count.

### Example 67

The image analysis system of any of examples 55-60 or 63-65, wherein determining the maturity of the stained blood cell comprises determining whether a pixel foreground count exceeds a threshold amount.

### Example 68

The image analysis system of any one of examples 55-67, wherein the system further comprises one or more chambers adapted to receive the biological sample and a lysing composition.

### Example 69

The image analysis system of any one or examples 55 to 68, wherein the system comprises one or more chambers configured to receive the biological sample and a staining composition.

### Example 70

The image analysis system of example 69, wherein the system further comprises a heater configured to heat the biological sample and the staining composition.

### Example 71

The image analysis system of example 71, wherein the heater comprises an induction coil.

### Example 72

The image analysis system of any one of examples 70-71, wherein the one or more chambers comprises two or more chambers, and the heater is linked to all of the two or more chambers.

### Example 73

The image analysis system of example 72, wherein the heater comprises a mounting bracket connected to all of the two or more chambers, and a heating element mounted to the mounting bracket.

### Example 74

A machine comprising: a camera; and means for determining maturity of cells in images captured by the camera.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and the claims, the phrase “means for determining maturity of cells in images captured by the camera” is a means plus function limitations as provided for in 35 U.S.C. § 112(f), in which the function is “determining maturity of cells in images captured by the camera” and the corresponding structure is a computer configured to determine the maturity for a cell using algorithms as described in the context of determining 902 maturity illustrated in FIG. 9, the classification 1000 (described as included in determining 902 maturity in some embodiments) of cells depicted in FIG. 10, generating 1300 maturity data as depicted in FIG. 13, determining 1402 maturity of cells in additional images as illustrated in FIG. 14, and utilizing 1502 a convolutional neural network and treating 1506 maturity provided by a machine learning model as the maturity of a cell as depicted in FIG. 15.

It should be understood that, in the above examples and claims, the term “set” should be understood as one or more things which are grouped together.

1-75. (canceled)

76. A computer-implemented image analysis method for detecting maturity of a blood cell, comprising:
providing a chamber configured to receive and mix a staining composition and a biological sample,
capturing an image of a stained blood cell from the biological sample; and
determining a maturity of the stained blood cell based on the image.

77. The image analysis method of claim 76, wherein:
the method further comprises:
treating the biological sample with a lysing agent; and
flowing the biological sample through a flowcell and past a camera; and
capturing the image of the stained blood cell with the camera is performed while the biological sample is flowing through the flowcell and past the camera.

78. The image analysis method of claim 76, wherein:
determining the maturity of the stained blood cell comprises classifying the stained blood cell; and
classifying the stained blood cell comprises classifying the stained blood cell as at least one of a reticulocyte or a platelet.

79. The image analysis method of claim 78, wherein the method further comprises:
obtaining a plurality of additional images, wherein each image from the plurality of additional images depicts an additional stained blood cell corresponding to that image;
for each image from the plurality of additional images, determining the maturity of the additional stained blood cell corresponding to that image; and
generating an analysis output based on a set of maturity data comprising the maturity of the stained blood cell and the maturities of the stained blood cells depicted in the plurality of additional images.

80. The image analysis method of claim 79, wherein generating the analysis output comprises determining at least one of an immature reticulocyte fraction and an immature platelet fraction for the biological sample.

81. The image analysis method of claim 77, wherein:
classifying the stained blood cell comprises using a convolutional neural network comprised by a machine learning model configured to, when presented with an input stained blood cell:
classify the input stained blood cell as a reticulocyte by classifying it into a reticulocyte class;
when the input stained blood cell is classified into the reticulocyte class, providing a maturity for the input stained blood cell;
classifying the input stained blood cell as a platelet by classifying it into a platelet class; and
when the input stained blood cell is classified into the platelet class, providing the maturity for the input stained blood cell; and
determining the maturity of the stained blood cell comprises:
presenting the stained blood cell to the machine learning model as the input stained blood cell; and
treating the maturity provided by the machine learning model as the maturity of the stained blood cell.

82. The image analysis method of claim 81, wherein:
the machine learning model is configured to classify the input stained blood cell into the platelet class and to, when the input stained blood cell is classified into the platelet class, provide the maturity for the input stained blood cell by classifying the input stained blood cell into a class selected from the group consisting of:
an immature platelet class; and
a mature platelet class; and
the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of:
an immature reticulocyte class; and
a mature reticulocyte class.

83. The image analysis method of claim 78, wherein classifying the stained blood cell comprises identifying a foreground in the image based on an intensity of each pixel in the image.

84. The image analysis method of claim 83, comprising:
calculating:
an average red intensity of pixels in the foreground of the image; and
an average blue intensity of pixels in the foreground of the image; and
classifying the stained blood cell based on the average red intensity and the average blue intensity.

85. The image analysis method of claim 76, wherein determining the maturity of the stained blood cell comprises utilizing a pixel foreground count.

86. A computer-implemented image analysis method for detecting maturity of a blood cell, comprising:
providing a flowcell configured to flow a biological sample therethrough, the blood sample comprising a stained blood cell;
obtaining an image of the stained blood cell; and
determining a maturity of the stained blood cell based on the image.

87. The image analysis method of claim 86, wherein:
determining the maturity of the stained blood cell comprises classifying the stained blood cell; and
classifying the stained blood cell comprises classifying the stained blood cell as at least one of a reticulocyte or a platelet.

88. The image analysis method of claim 87, wherein the method further comprises:
obtaining a plurality of additional images, wherein each image from the plurality of additional images depicts an additional stained blood cell corresponding to that image;
for each image from the plurality of additional images, determining the maturity of the additional stained blood cell corresponding to that image; and
generating an analysis output based on a set of maturity data comprising the maturity of the stained blood cell and the maturities of the stained blood cells depicted in the plurality of additional images.

89. The image analysis method of claim 88, wherein generating the analysis output comprises determining at least one of an immature reticulocyte fraction and an immature platelet fraction for the biological sample.

90. The image analysis method of claim 87, wherein classifying the stained blood cell comprises utilizing a convolutional neural network.

91. The image analysis method of claim 90, wherein:
the convolutional neural network is comprised by a machine learning model configured to, when presented with an input stained blood cell:
classify the input stained blood cell as a reticulocyte by classifying it into a reticulocyte class;
when the input stained blood cell is classified into the reticulocyte class, providing a maturity for the input stained blood cell;
classifying the input stained blood cell as a platelet by classifying it into a platelet class; and
when the input stained blood cell is classified into the platelet class, providing the maturity for the input stained blood cell; and
determining the maturity of the stained blood cell comprises:
presenting the stained blood cell to the machine learning model as the input stained blood cell; and
treating the maturity provided by the machine learning model as the maturity of the stained blood cell.

92. The image analysis method of claim 91, wherein:
the machine learning model is configured to classify the input stained blood cell into the platelet class and to, when the input stained blood cell is classified into the platelet class, provide the maturity for the input stained blood cell by classifying the input stained blood cell into a class selected from the group consisting of:
an immature platelet class; and
a mature platelet class; and
the machine learning model is configured to classify the input stained blood cell into the reticulocyte class and to, when the input stained blood cell is classified into the reticulocyte class, provide the maturity for the input stained blood cell by classifying the input stained blood cell into a class selected from the group consisting of:
an immature reticulocyte class; and
a mature reticulocyte class.

93. The image analysis method of claim 87, wherein classifying the stained blood cell comprises identifying a foreground in the image based on an intensity of each pixel in the image.

94. The image analysis method of claim 93, comprising:
calculating:
an average red intensity of pixels in the foreground of the image; and
an average blue intensity of pixels in the foreground of the image; and
classifying the stained blood cell based on the average red intensity and the average blue intensity.

95. The image analysis method of claim 86, wherein determining the maturity of the stained blood cell comprises utilizing a pixel foreground count.
